(19) United States
(12) Patent Application Publication
(10) Pub. No.: US 2024/0083421 A1
(43) Pub. Date: Mar. 14, 2024

(54) SYSTEM AND METHODS FOR TIME-OF-FLIGHT (TOF) LIDAR INTERFERENCE MITIGATION

(71) Applicant: Motional AD LLC, Boston, MA (US)

(72) Inventors: Geng Fu, Belmont, MA (US); Yong Zhou, New Kensington, PA (US)

(21) Appl. No.: 17/931,056

(22) Filed: Sep. 9, 2022

(51) Int. Cl. B60W 30/095; G06V 20/58

(52) U.S. Cl. CPC B60W 30/0956; G06V 20/58; B60W 2420/52; B60W 2554/4049

(57) ABSTRACT

Various methods and systems are disclosed to improve the reliability and accuracy of a time of flight lidar systems by generating real-time background signals for individual pixels of a sensor of the lidar detection system and use the background signals to generate confidence signals. The confidence signal indicates validity of a return signal or a probability that the return signal is not associated with interference with another lidar or light source. The confidence signals may be used by the lidar system to reduce the false alarm rate of the lidar.

### INCORPORATION BY REFERENCE TO ANY PRIORITY APPLICATIONS

Any and all applications for which a foreign or domestic priority claim is identified in the Application Data Sheet as filed with the present application are hereby incorporated by reference under 37 CFR 1.57.

### BRIEF DESCRIPTION OF THE DRAWINGS

FIG. 1A is a diagram illustrating a Light Detection and Ranging (lidar) system that detects objects in an environment by emitting optical probe beams and receiving the respective reflected optical beams.

FIG. 1B is a diagram illustrating interference between two Light Detection lidar systems operating in an environment.

FIG. 1C is a diagram illustrating three different lidar signal coding schemes for coding optical probe signals in time, amplitude, or wavelength domain.

FIG. 2A is a diagram illustrating a scanning lidar system.

FIG. 2B is a diagram illustrating a flash lidar system.

FIG. 2C is a diagram illustrating a mechanical lidar system.

FIG. 3 is a block diagram illustrating an example lidar detection system.

FIG. 4A is a diagram illustrating an example sensor used in a lidar detection system and a close up view of a pixel of the plurality of pixels included in the sensor.

FIG. 4B is a diagram illustrating an example sensor of a lidar detection system that includes a reference subpixel.

FIG. 5A is a diagram illustrating an example signal and noise photocurrents generated by a pixel of a lidar sensor and a threshold level used to generate a return signal based on time-to-digital conversion.

FIG. 5B is a diagram illustrating an example signal and noise photocurrents generated by a pixel of a lidar sensor, and the threshold level and sampling pulses used to generate a digital return signal based on analog-to-digital (A-to-D) conversion.

FIG. 6 is a block diagram illustrating another example lidar detection system that includes a detection control system and an event validation circuit.

FIG. 7 is a diagram illustrating signal and noise photocurrents generated during a measurement time interval that includes several measurement time windows.

FIG. 8 is a block diagram illustrating an example of a dynamically controlled lidar detection system.

FIG. 9 is a diagram illustrating an example spatial optical filter for filtering light received by the optical system of a lidar detection system.

FIG. 10 is a flow diagram illustrating an example of a process implemented by a processor of the readout circuit to generate return signals and background signals 325.

FIG. 11 is a flow diagram illustrating an example of a process implemented by a processor of the detection control system to reduce the false alarm rate (FAR) of the lidar detection system by controlling the optical system, the sensor, and/or the readout circuit.

FIG. 12 is a flow diagram illustrating an example of a process implemented by a processor of the event validation circuit for generating a confidence signal.

FIG. 13 is an example environment in which a vehicle including one or more components of an autonomous system can be implemented.

FIG. 14 is a diagram of one or more systems of a vehicle including an autonomous system.

FIG. 15 is a diagram of components of one or more devices and/or one or more systems of FIGS. 13 and 14.

FIG. 16 is a diagram of certain components of an autonomous system.

### DETAILED DESCRIPTION

### Lidar System Overview

Self-driving vehicles preferably include highly accurate and reliable sensors for detecting objects and calculating their distances from the vehicle. Among various technologies developed for object detection and ranging, laser-based range finders are often used for autonomous driving systems due to their high resolution and accuracy. Laser based range finders or laser range finders are sometimes called Light Detection and Ranging (lidar) or Laser Detection and Ranging (ladar). The acronyms “lidar” and “ladar” may be used interchangeably to refer to an optical system that detects objects using laser light.

Lidar systems use light beams (e.g., laser beams) to detect objects in the environment surrounding the lidar and determine their distances from the lidar. In some cases, a lidar may also determine the velocity of an object with respect the lidar or determine optical characteristics (e.g., surface reflectivity) of an object. High resolution (e.g., high spatial resolution for detecting objects) and high accuracy of lidar systems have made them preferred sensors for many applications. In particular, lidar systems are used in various autonomous driving systems for continuous scanning of the surrounding environment of a vehicle to avoid collision between the vehicle and objects in the environment. A lidar system detects objects by sending optical probe beams (also referred to as lidar beams) to the environment and detecting the respective optical reflections off of the objects in the environment. A detection system of the lidar generates a return signal indicative of detection of a portion of an optical probe beam reflected by an object in the environment.

In addition to the reflections of the optical probe beams emitted by the lidar, in some cases, the detection system of the lidar may receive light generated by other sources different from the lidar (e.g., other lidars, sun, traffic lights, cars, ambient light, and the like). In some such cases, light generated by the other sources (herein referred to as background light or environmental light) may interfere with the detection of the reflections of the optical probe signals and increase the noise level of the detection system. As such, the presence of background light may result in inaccurate object detection and cause safety concerns for a system (e.g., a vehicle) that used the lidar for detecting objects.

The disclosed methods and systems addresses problems associated with reception of background light by the detection system of the lidar, for example, by identifying a portion of detected light associated the background light, and using the corresponding data/information to modify the detection system or to determine the reliability of return signals. In various embodiments, the information as to background light may be used to reduce a false alarm rate of the lidar and/or provide information usable to assess the reliability of the return signals. In one embodiment, information as to background light is used to modify the detection system to improve the signal-to-noise ratio (SNR) of the detection system. For example, information as to background light may be used to adjust (e.g., dynamically adjust) a threshold level used for distinguishing reflection of light emitted by the lidar (e.g., reflected by an object), from background light. In some other examples, other parameters the lidar may be dynamically controlled to reduce background light and improve the signal-to-noise ratio of the detection system. In another embodiment, information as to background light is used to determine a confidence value for a return signal, providing an objective measurement as to reliability of corresponding detection event.

The designs, systems, and method described below could be incorporated into such various type of autonomous vehicles and self-driving cars for examples those disclosed in U.S. patent application Publication Ser. No. 17/444,956, entitled “END-TO-END SYSTEM TRAINING USING FUSED IMAGES” and filed Aug. 12, 2021, and Ser. No. 17/443,433, entitled “VEHICLE LOCATION USING COMBINED INPUTS OF REDUNDANT LOCALIZATION PIPELINES” and filed Jul. 26, 2021, the entire contents of which are incorporated by reference herein and made a part of this specification.

In some cases, an optical probe beam emitted by a lidar system may comprise an optical probe signal. In some such cases, the lidar may detect an object and determine a distance between the object and the lidar by illuminating the object with an optical probe signal and measuring a delay between emission of the optical probe signal and reception of the corresponding reflected optical signal from the object. In some cases, the incident optical probe signal may comprise a temporal variation of an optical property (e.g., amplitude, phases, frequency, polarization) of a laser beam emitted by the lidar. In some cases, the incident optical probe signal may comprise laser pulses, which may be coded using, for example, a temporal, amplitude, phase, or polarization coding scheme. For example, the optical probe signal can be a single laser pulse or pulse train and the lidar may determine the distance from the object by measuring a delay or time-of-flight (ToF) between the transmission of one or more incident laser pulses, and reception of the corresponding reflected laser pulses. In some cases, lidars that determine the distance from the objects based on the time-of-flight of a laser pulse may be referred to as ToF lidars. A ToF lidar may also determine the optical reflectivity of the object surface using the reflected laser pulses. In some cases, a ToF lidar may generate return signals usable to determine a position of an object and the reflectivity of the object surface.

In some applications (e.g., to control and guide an autonomous vehicle in a complex driving environment), a lidar can continuously scan an environment (e.g., environment surrounding the vehicle) with a relatively high scanning speed to capture the changes in the position of the objects in the environment. For example, the lidar may scan the surrounding environment by rotating one or more optical probe beams (e.g., laser beams) around a rotational axis while scanning the direction of propagation of the laser beams in a plane parallel to the rotational axis.

The reliability of the lidar system may depend on the accuracy of the optical detection process, which may be affected by the amount of noise received by or generated in the detection system of the lidar. In some cases, noise (e.g., external noise) may increase the probability of false alarms or invalid detection events. Various sources of noise may interfere with the optical detection process and degrade the performance of the lidar by increasing the probability of missing light associated with reflection of optical probe beams received by the lidar system, or falsely identifying detected light generated by other sources as reflection of an optical probe beam emitted by the lidar system (a false alarm or invalid event). Any light that is not associated with an optical probe signal emitted by the lidar but is received and detected by the lidar system may be considered optical noise and can reduce the accuracy and reliability of the return signals and/or increase the false alarm rate of a lidar system. In some cases, optical noise can be associated with background light that is generated by light sources (e.g., sun, vehicles, streetlights, and the like), in the environment surrounding the lidar. Given the high optical sensitivity of the lidar detection system, even low level light emitted by a source in an environment scanned by the lidar may be detected by the lidar detection system and interfere with the detection and range finding operation of the lidar. The detection probability, accuracy, and false alarm rate (FAR) of a lidar system can be limited by the signal-to-noise (SNR) ratio of the detection system of the lidar.

In some cases, the performance of a lidar, in particular the long-range detection capability of the lidar (e.g., detecting objects at distances larger than 200 meters), may be determined by the signal-to-noise-ratio (SNR) of the lidar return signal. In various implementations, noise associated with background light (light not associated with the optical probe beams emitted by the lidar) that reaches the sensor element of lidar detection system may be the dominant noise in a lidar system. Sources of background light may include but are not limited to: sun, vehicles moving around the lidar, streetlights, light generated by other lidar systems, light generated by other sources and reflected by objects in the environment, and the like.

As such, there is a need for methods and systems that can improve the reliability of lidar systems in the presence of background light in an environment monitored by the lidar systems. The systems and methods disclosed herein may be used to reduce the impact of background light on the detection and range finding function of various lidar systems. In some cases, the lidar detection system may measure background light and generate real-time background signals for one or more light sensing elements (e.g., pixels of a sensor) of a plurality light sensing elements of the lidar detection system. A background signal may indicate a level or an amount of background light received by the corresponding light sensing element. In some cases, the background signals may be used to reduce a false alarm rate (FAR) of the lidar, for example by identifying and reducing the noise associated with background light in real-time and thereby reducing the signal-to-noise ratio of the detected signal. For example, the background signals may be used to control the optical system, the sensor and/or the readout circuit of the lidar, and thereby improving the signal-to-noise ratio of detected signal. In some cases, background signals may be used to provide an indication of level background noise present during a measurement.

In some cases, a lidar detection system may include a detection control system that uses the background signals to increase the signal-to-noise ratio (SNR) of the signals generated by a lidar sensor (sensor signals) and/or lidar return signals generated by the lidar by dynamically controlling one or more subsystems of the lidar system (e.g., subsystems in the lidar detection system). In some cases, the dynamic control may include adjusting a parameter of one or more subsystems based on the background signals to reduce the FAR of the lidar. In some such cases, the dynamic control may include adjusting a parameter of one or more subsystems based on the background signals to reduce the contribution of background light to the photocurrents and/or return signals generated by the detection system of the lidar of by a subset of elements in the detection system. For example, background signals may be used to dynamically change the collecting FOV of the optical system, configuration of the sensors, and/or parameters of a readout circuit (e.g., a true even validation threshold level).

In some examples, the detection control system may control a parameter of an optical system of the detection system (e.g. the size of collecting FOV) to reduce the amount of background light received from the environment or reduce the portion of received background light is directed to the detection system, where the sensor is configured to convert received light to photocurrents. In some cases, the detection control system may control a parameter of the sensor to reduce a portion of photocurrents generated by the background light received by the sensor from the optical system. In some examples, the detection control system may change the active area of the sensor to control the background light contribution on a sensor signal.

In some cases, the detection control system may control a parameter of a readout system of the detection system that generates return signals upon receiving sensor signals from the sensor. For example, the method described herein may dynamically control a readout threshold (e.g. true event validation threshold) of the readout system to improve detection probability while maintaining the false alarm rate (FAR) below a set level. In some cases, the method described herein may dynamically control a readout threshold (e.g. true event validation threshold) of the readout system to reduce the FAR below a threshold value. In some cases, the readout threshold can be a threshold level used to identify a true even (detection of reflected light associated with an optical probe signal emitted by the lidar), based on a sensor signal. In some cases, the FAR may comprise a rate of generation of return signals that are not associated with a reflection of an optical probe signal emitted by the lidar.

Additionally, some of the lidar detection systems described below may use the background signals to generate a confidence signal indicative of the reliability of a return signal generated by the detection system of a lidar. In some embodiments, the lidar detection systems described below may use the information of both the “true” event detected and real-time background signals to generate a confidence signal indicative of the reliability of a return signal generated by the detection system of a lidar. For example, the lidar detection system may use the real-time background signals associated with sensor signals received by the lidar senor, to estimate a real-time false alarm rate (FAR), and generate the confidence signal as the supplement of the corresponding return signal. The return signal may indicate a 3D position and, in some cases, surface reflectivity of a detected object and the corresponding confidence signal may indicate a level of confidence for the 3D position and the surface reflectivity indicated by the return signals. In some cases, the lidar detection systems described below may use a detected true event and estimated FAR to generate a confidence signal.

In some cases, a lidar detection system may include a detection control system for dynamic control of one or more systems of the detection system based on feedback indicative of a noise level (e.g., background noise level). In some cases, a lidar detection system having a detection control system may not generate confidence signals for the return signals. In some cases, a lidar detection system that generates confidence signals may not include a detection control system. In other embodiments, a lidar detection system may be dynamically controlled by a detection control system and generate confidence signals for at least a portion of the return signals.

Advantageously, some of the methods described herein may be implemented without modifying a conventional lidar detection system at a hardware level. For example, some of the methods described below may be implemented by reconfiguring the signal processing paths and procedures in a readout circuit of a lidar system (e.g., at software level). In some cases, the implementation may include reprograming a reconfigurable circuit (e.g., a field-programmable gate array) included in the detection system.

### Lidar System Operation

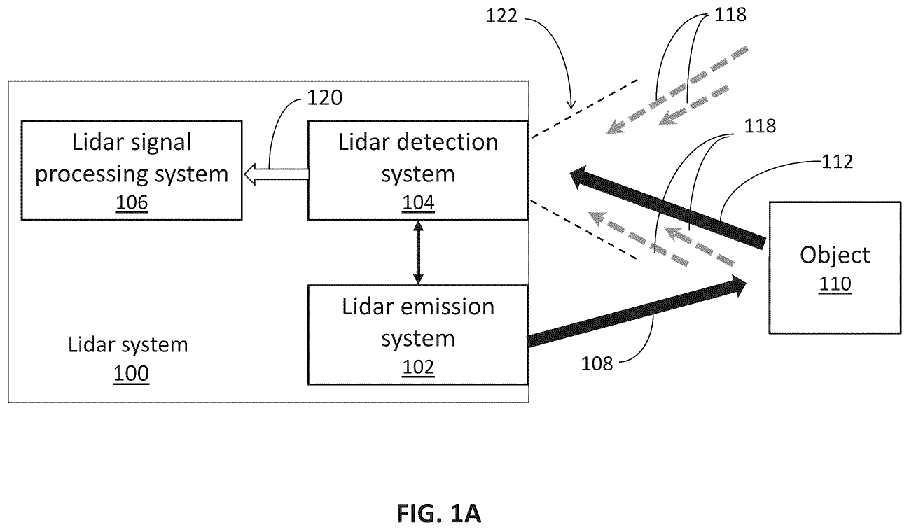

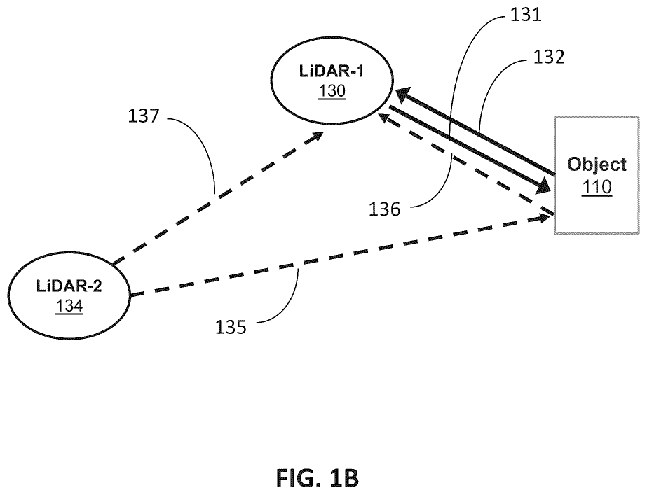

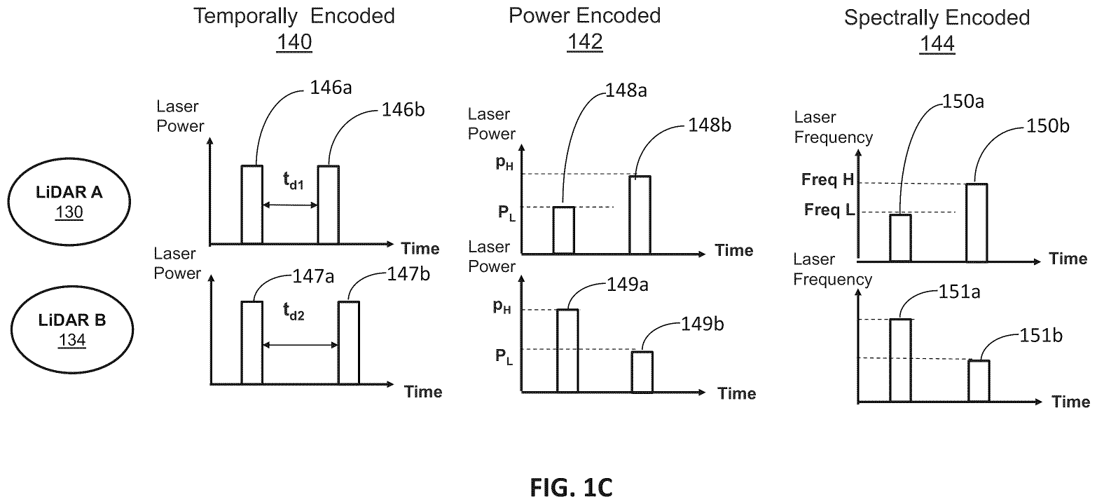

FIG. 1A shows an example of a lidar system 100 that detects objects in an environment surrounding the lidar system 100 and determines distances between the objects and the lidar system 100. In some examples, the lidar system 100 may determine a three-dimensional (3D) position, and/or reflectivity of an object in the environment. In some cases, the lidar system 100 may additionally determine a velocity of an object, e.g., relative to the lidar system. The lidar system 100 includes a lidar emission system 102 (referred to as emission system 102) that emits optical probe beams, and a lidar detection system 104 (referred to as detection system 104) that receives the reflected optical beams and generates return signals. In some cases, the lidar system 100 may determine a reflectivity of an object surface, e.g., detected signal intensity with distance and optical correction.

The lidar system 100 may detect an object 110 by emitting an optical probe beam 108 (e.g., a pulsed laser beam) and receiving a reflected optical beam 112 corresponding to a reflection of the optical probe beam 108. In some cases, the optical probe beam 108 may comprise one or more optical probe signals (e.g., optical pulses) and the reflected optical beam 112 may comprise one or more reflected optical signals (e.g., reflected optical pulses). An optical probe signal may comprise a temporal variation of an optical property (e.g., amplitude, phase, or frequency) of the corresponding optical probe beam. In some examples, an optical probe signal may comprise a pulse train. The lidar system 100 may further include a detection system 104, and a lidar signal processing system 106. The emission system 102 may emit the optical probe beam 108 toward the object 110, and the detection system 104 may receive the reflected optical beam 112. In some examples, the optical probe beam 108 may comprise an optical signal (e.g., an optical pulse) at an emission time (t1) and the reflected optical beam 112 may comprise a reflected optical signal received by the detection system 104. The detection system 104 may determine an amplitude and an arrival time (t2) of the reflected optical signal. In some cases, the detection system may determine a delay (t2-t1) between an emission time (t1) and the arrival time (t2). In some implementations, the detection system 104 may generate one or more return signals 120, by converting reflected optical signals to electric signals (e.g., a photocurrents or a photovoltages), and using them to generate sensor signals. In various implementations, a sensor signal can be a digital or analog signal. In some cases, a return signal may comprise the electric signal or an amplified version of the electric signal. In some cases, the return signal may indicate the arrival time (t2), the magnitude (e.g., power or intensity) of the reflected optical signal, and/or the delay (t2-t1) between the emission time (t1) and the arrival time (t2). The detection system 104 may include a plurality of sensing elements (e.g., pixels) that each generate a separate sensor signal.

The lidar system 100 may further comprise a lidar signal processing system 106 that receives the return signals 120 and determines the presence of the object 110 in the environment and calculates a distance between the lidar system 100 and the object 110 based at least in part on the return signals 120. In some examples where the return signal indicate a delay (t2-t1) between the emission time (t1) and the arrival time (t2) the lidar signal processing system 106 may use the delay to calculate the distance between the lidar system 100 and the object 110. In some examples, where a return signal indicates the arrival time (t2), the lidar signal processing system 106 may determine the delay between the emission time (t1) and arrival time (t2), and then use the delay to calculate the distance between the lidar system 100 and the object 110.

In various implementations, the optical probe beam (108) may have a wavelength within an operating wavelength range of lidar system 100. In some cases, the operating wavelength range of the lidar is in the infrared (IR) wavelength range. In some cases, the operating wavelength range of the lidar is in the near-IR (NIR) wavelength range. In some such cases, the optical probe beam (108) may have a wavelength from 800 nm to 1200 nm, or from 1200 nm to 1800 nm. In some cases, the detection system 104 may have higher sensitivity for detecting light having a wavelength within the operating wavelength range of the lidar system 100.

In some cases, the detection system 104 may be configured to receive light or light beams propagating toward an entrance aperture of the detection system 104 along directions within a field of view (FOV) 122 of the detection system 104. In some examples, light beams that are incident on the entrance aperture of the detection system 104 and propagate along a direction within the FOV 122, may be received by a sensor that generates an electric signal (a sensor signal) proportional with the power or intensity of the received light. As such, in addition to the reflected optical beam 112, the detection system 104 may receive background light 118 that is not associated with a reflection of the optical probe beam 108 but propagates toward the detection system 104 along a direction within the FOV 122 of the lidar system 100. In some cases, background light 118 may include sun light, light associated with other lidar systems, light emitted by a moving vehicle, or constant light emitted by a static source (e.g., a streetlamp). The sensor may comprise one or more optical-to-electrical converters such as photodiodes (PDs), avalanche photodiodes (APDs), Silicon photomultipliers (SiPM), single-photon avalanche photodiodes (SPADs), or SPAD arrays.

In some cases, the background light 118 received by the detection system 104 may decrease a noise level of the detection system 104 and reduce a signal-to-noise ratio of a return signal or a signal generated by the sensor (also referred to as sensor signal). In some examples, the signal-to-noise ratio (SNR) may be defined as a ratio of a signal (e.g., associated with a return signal or a sensor signal) generated as a result of receiving the reflected optical beam 112, to noise associated at least partially with the background light 118. The sensor signals generated by the background light 118 may be referred to as background noise. When the background light 118 received by the detection system 104 reduces the signal-to-noise ratio of the sensor signals, the accuracy and reliability of the corresponding return signals 120 generated using these sensor signals may decreased. For example, when the amplitude of a signal generated by background light 118 is not significantly smaller than the amplitude of a signal generated by the reflected optical signal carried by the reflected optical beam 112, the detection system 104, may not distinguish the signal associated with the reflected optical signal from the back ground noise associated with the background light, or may determine an erroneous arrival time (t2) different from the time at which the reflected optical signal is received by the detection system 104. In some cases, the background light 118 received by the detection system 104 may increase a rate of generation of false return signals (herein referred to as false alarm rate or FAR), which are not associated with reflections of optical probe signals emitted by the lidar system 100. For example, an optical signal generated by a source different from the emission system 102 (e.g., sun, other vehicles, and the like) may be received by the detection system 104 and generate a sensor signal that is falsely identified by the detection system 104 as a reflected optical signal associated with an optical probe signal emitted by the lidar emission system. In some cases, the optical probe beam emitted by a lidar (e.g., optical probe beam 108) may comprise a narrow beam of light having low divergence. In some such cases, the divergence of the optical probe beam 108 can be less than 0.5 degrees, less than 2 degrees, less than 5 degrees, or less than 10 degrees. In some cases, the optical probe beam 108 may comprise a beam of light beam having a large degree of divergence. In some such cases, the divergence of the optical probe beam 108 can be larger than 10 degrees, larger than 20 degrees, or larger than 30 degrees. In various embodiments, a lidar system may move, scan, or rotate one or more optical probe beams over an azimuthal angular range with respect to a rotational axis of the lidar to scan an environment. In some cases, a detection system of a lidar may have a wide or a narrow field of view (FOV). In some cases, a wide field of view may have azimuthal and polar angular widths larger than 5 degrees, larger than 30 degrees, or larger than 90 degrees. In some cases, a narrow field of view may have azimuthal and polar angular widths smaller than 0.05 degrees, smaller than 0.2 degrees, or smaller than 2 degrees.

### Interference Between Lidars

In some cases, multiple lidars may operate in the same environment. In some such cases, optical probe beams emitted by a first lidar or reflections of the optical probe beams emitted by the first lidar may be received by the detection system of a second lidar and interfere with the detection and range finding operation of the second lidar. In some examples, the first and the second lidar may emit optical probe beams and signals having the same or similar optical and/or temporal characteristic. For example, the first and the second lidars may have similar or substantially identical operating wavelength ranges. In some cases, the optical probe beams emitted by the first and the second lidar may have the wavelengths that are detectable by detection systems of the first and the second lidars. Thus, the detection systems of the second lidar may not be capable of effectively distinguishing the reflected optical beams and the corresponding reflected optical signals associated with the first and the second lidars. In various implementation, interference between two lidars may degrade the signal-to-noise ratio (SNR) of the return signals generated by the one or both lidars. In some such cases, the mutual interference between two lidars may increase their FAR.

In some cases, an optical probe signal emitted by a lidar may generate multiple reflected optical signals that are received by the lidar via different optical paths including a direct optical path from an object illuminated by the corresponding optical probe beam. In some such cases, the multiple reflected optical signals may interfere with each other and generate multiple sensor signals. In some cases, one or more sensor signals may be falsely identified by the detection system as a reflected optical signal generated by a reflected optical beam received by the detection system from the object via straight optical path. As such, the detection system may generate return signals falsely indicating the presence of multiple objects at artificial distances different from the actual distance between the object and the lidar.

In some examples, lidar detection system 104 may generate a confidence signal for one or more return signals (associated with one or more detection events) generated by the detection system 104. In some cases, when the background light received by a lidar is associated with light generated by another lidar system, the confidence signal may indicate a probability that the one or more return signals are generated by reflections of the optical probe beams emitted by the lidar and not the background light. In some cases, when multiple reflections of an optical probe beam emitted by the lidar are received by the detection system of the lidar, the confidence signal may indicate a probability that a return signal is generated by reflection of the optical probe beam that is received directly (via a straight optical path) from the object that was illuminated by the optical probe beam. In some cases, the lidar detection system 104 may generate a confidence signal indicative of the false alarm rate at a sensor output.

In some examples, the optical probe signals emitted by the lidar may be coded optical probe signals. A coded optical probe signal associated with an optical probe beam may include two or more optical pulses having specific optical characteristics relative to each other (e.g., intensity, duration, or delay between pulses), making the optical probe signal and the resulting reflected optical signals recognizable from other optical signals associated with other optical probe beams emitted by the same lidar, by other lidars, or by other optical systems that may emit optical signals (e.g., optical signals having temporal characteristics close to that of the optical probe signals emitted by the lidar). In some cases, a first optical probe signal associated with a first optical beam corresponding to a first scanned field of view (FOV) of a lidar may be coded using a first code to distinguish the first optical probe signal from a second optical probe signal coded with a second code different from the first code, where the second optical probe signal is associated with associated a second optical beam corresponding with a second scanned FOV. In some examples, the readout for a first pixel or a first group of pixels of the lidar sensor may be configured to detect sensor signals associated with optical probe signals coded using a first code and the readout for a second pixel or a second group of pixels may be configured to detect sensor signals associated with optical probe signals coded using a second code different that than the first code (pixel based coding scheme).

While coding of the optical probe signals may provide a first level of protection against interference with lights emitted by other lidars in the environment, it may not be sufficient to eliminate interference or reduce its impact on the lidar performance below a desired level. In some examples, the detection system 104 may generate confidence signals indicating a probability of a return signal is not a false return signal associated with interference with another lidar or another light source. As such, confidence signals may be used by the lidar system (or another system that may receive the return signals), to avoid using false return signals, that are not eliminated using on the coding technique, for determining the presence of objects and their distance from the lidar.

FIG. 1B shows a first lidar 130 and a second lidar 134 (e.g., a first lidar system that is the same as, or similar to, lidar system 100 of FIG. 1A) scanning the same environment. In the example shown, the first optical probe signal 131 is reflected by an object 110 and the corresponding reflected optical signal 132 is directly received by the first lidar 130. In some cases, the first optical probe signal 131 may be a coded optical probe signal (e.g., comprising two or more optical pulses having different amplitudes, delays, or frequencies).

In some cases, the second lidar 134 (e.g., a second lidar system that is the same as, or similar to, lidar system 100 of FIG. 1A) may emit a second optical probe signal 135 that is received by the first lidar 130, after being reflected by the object 110. Additionally, the second lidar 134 may emit a third optical probe signal 137 that is directly received by the first lidar 130. In some cases, the detection system of the first lidar 130 may determine the third optical probe signal 137 and the second reflected optical signal 136 do not match a code included in the first optical probe signal 131 and therefore does not generate any return signal based on these signals.

In some other cases, despite coding of the first optical probe signal 131, the detection system of the first lidar 130 may falsely identify the third optical probe signal 137 and the second reflected optical signal 136 generated by the second optical probe signal 135, as the reflections of the optical probe signals emitted by the first lidar 130. In some such cases, the first lidar 130 may generate return signals based on the third optical probe signal 137 and the second reflected optical signal 136 (this can be an example of detecting a true event with incorrect de-coding). Such return signals are examples of false events that may falsely indicate presence of an object, or indicate an incorrect distance between the first lidar 130 and the object 110. In some such cases, the detection system of the first lidar 130 may generate a confidence signal indicative of low probability of the return signal being associated with the optical probe signal 131. As such, the lidar signal processing system 106 (or system separate from the lidar) that receives the return signal and the confidence signal may discard the return signal.

### Pulse Coded Lidar Probe Signals

As described above, in some cases a lidar may generate coded optical probe signals. In some cases, a coded optical probe signal emitted by a lidar may comprise two or more optical pulses sequentially emitted with a delay t_d. Such optical probe signal may be referred to as a “pulse coded optical signal”. For example, an optical probe signal may comprise a delayed optical pulse emitted t_d seconds after the emission an initial optical pulse. In some cases, the delay t_d between the two optical pulses, a ratio between the amplitude of the two optical pulses, a phase difference between the two optical pulses, or a frequency difference between the two optical pulses may be used to as a unique identifier for identifying the optical probe signals emitted by a specific lidar. In some such cases, this unique identifier may be used by a lidar to distinguish the received optical signals associated with reflections of the optical probe signals emitted by the lidar, and the received optical signals associated with other optical probe signals emitted by the lidar or other light sources

FIG. 1C shows three different pulse coding schemes that may be implemented by a first and a second lidar system (e.g., the first lidar system 130 and the second lidar system 134 shown in FIG. 1B), or a first scanned FOV and a second scanned FOV in a same LiDAR, to avoid interference between the optical probe signals or the corresponding reflections. In some cases, the lidar probe signals may be temporally encoded 140. For example, the first optical probe signal emitted by the first lidar 130 may include a delayed pulse 146b emitted after a first delay t_d1 with respect to an initial pulse 146a, while the second optical probe signal emitted by the second lidar 134 may include a delayed pulse 147b emitted after a second delay t_d2 with respect to an initial pulse 147a.

In some cases, the lidar probe signals may be power encoded 142. For example, the first optical probe signal emitted by the first lidar 130 may include an initial pulse 148a having an optical power P_L lower than the optical power of a delayed pulse 148b having a high optical power P_H and emitted after a delay with respect to the initial pulse, while the second optical probe signal emitted by the second lidar 134 may include an initial pulse 149a having an optical power P_H higher than the optical power of a delayed pulse 149b having a low optical power P_L and emitted after with delay with respect to the initial pulse.

In some cases, the lidar probe signals may be spectrally encoded 144. For example, the first optical probe signal emitted by the first lidar 130 may include an initial pulse 150a having an optical frequency F_L lower than the optical frequency of a delayed pulse 150b having a high optical frequency F_H and emitted after a delay with respect to the initial pulse, while the second optical probe signal emitted by the second lidar 134 may include an initial pulse 151a having an optical frequency F_H higher than the optical frequency of a delayed pulse 151 having a low optical frequency F_L and emitted after a delay with respect to the initial pulse.

While depicted separately in FIG. 1C, in some instances lidar probe signals may be coded according to a combination of any of temporal encoding, power encoding, and wavelength encoding.

In various implementations, the effectiveness of the pulse-coding method described above for mitigating interference between different lidar systems (or other systems in the environment that may emit optical signals), can be reduced when a large number of sensors are employed, or a larger of optical signal are implemented in a short time interval, such as autonomous vehicle application cases. In various implementations, a lidar detection system may mitigate the impact of these interference by generating confidence signals for each detected event or object. In some other implementations, a detection system 104 may use coded optical probe signals and also generate confidence signal signals as a second layer of protection against FAR associated with interference.

In various implementations, a confidence signal may be generated based on the background signals from individual sensing elements of the detection system of the lidar, where a background signal indicates a level of background light received by the corresponding sensing element.

### Different Types of Lidars

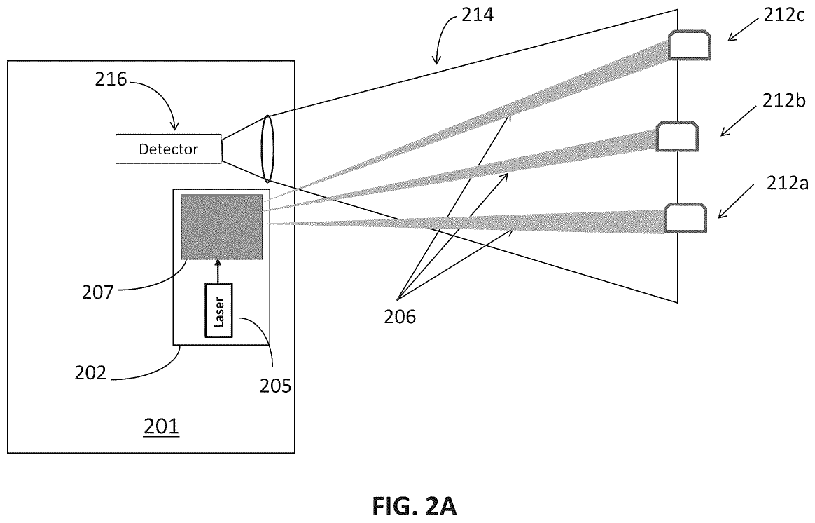

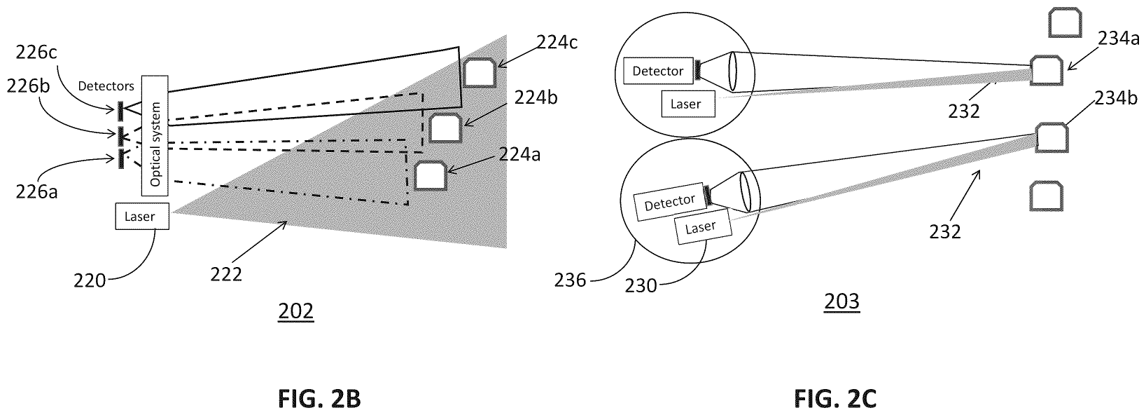

FIG. 2A illustrates a scanning lidar system 201 that scans one or more narrow optical probe beams 206 over a field of view 214 (e.g., a wide field of view) of a detection system 216 of the scanning lidar system 201 and detects the corresponding reflected optical beams received through the field of view 214. In some cases, the scanning lidar system 201 may comprise an emission system 202 that scans the one or more light beams generated by a laser source 205 using an optical scanning system 207 (e.g., a rotating mirror). In some cases, the detection system 216 is configured to detect light received through the field of view 214 and generate return signals indicative of presence of one or more objects (e.g., vehicles, bicycle, pedestrian) within the field of view 214 of the scanning lidar system 201, and a distance between the objects and the scanning lidar system 201. For example, the emission system 202 may generate and steer an optical beam 206 within the field of view 214 to detect multiple objects located within the field of view 214 of the detection system 216. In the example shown, as the optical probe beam 206 rotates between different angular positions with respect to the emission system 202, it may be reflected by a first object 212a at a first angular position, by a second object 212b at a second angular position, and by a third object 212c at a third angular position. A portion of light reflected by each object 212a-c that propagates within the field of view 214 of the scanning lidar system 201, may reach the detection system 216 and generate one or more sensor signals. The scanning lidar system 201 may use the sensor signals generated by the light reflected by the first object 212a, the second object 212b, and the third object 212c to generate a first, second, and a third signal indicative of the presence of the objects in the field of view 214 and usable for estimating respective distances between the objects and the scanning lidar system 201. In some cases, the detection system 216 may have a stationary field of view 214. In some cases, the field of view 214 of the detection system 216 can be reconfigurable (e.g., by a control system of the detection system 216). In some examples, the detection system 216 may receive background light that is not associated with the reflection of the optical probe beam 206 by a object via the field of view 214. In some such cases, the background light may saturate the detection system 216 or decrease the signal to noise ratio of the sensor signals and the return signals.

FIG. 2B illustrates a flash lidar system 202 that may use a single optical probe beam 222 (e.g., a highly divergent beam) generated by an emission system 220 of the flash lidar system 202 that generates the optical probe beam 222 to illuminate a field of view (e.g., a large field of view). The flash lidar system 202 may comprise a detection system that measures reflected portions of the optical probe received via different sections of the field of view using a two dimensional (2D) array of detectors (e.g., pixels). The pixels and an optical system (e.g., one or more lenses) may be configured such that each pixel detects light received from a specific portion of the field of view (e.g., received from a specific direction). For example, optical probe beam 222 may illuminate a first 224a, second 224b, and a third 224c object and reflected light from each object may be received by a first 226a, second 226b, and third 226c objects respectively.

FIG. 2C illustrates a mechanical lidar system 203 that may use a single optical probe beam 232 (e.g., a low divergence optical beam) generated by an emission system 230 of the mechanical lidar system 203 that generates the optical probe beam 232 to illuminate a narrow field of view (e.g., a large field of view). In some cases, the optical probe beam 232 may comprise two or more beams. The mechanical lidar system may rotate the optical probe beam 232 to scan the environment. The mechanical lidar system 203 may comprise a detection system 236 that measures a reflection of the optical probe beam 232 received via a field of view of the detection system 236. The mechanical lidar system 203 may rotate the detection system 236 and the corresponding field of view together with the emission system 230 such that the optical probe beam 232 and its reflections are transmitted and received within a narrow angular width aimed toward an object. For example, at a first lidar orientation the optical probe beam 232 and the FOV of the detection system 236 may be directed to a first object 234a, and at a second lidar orientation the optical probe beam 232 and the FOV of the detection system 236 may be directed to a second object 234b.

In various implementations, any of the lidar system described above can be a ToF lidar system. Various methods and systems described below may be implemented in any of the lidar systems described above to increase the signal-to-noise ratio of the return signals (or sensor signals), generate confidence signals indicative of a validity of the return signals, and/or reduce the false alarm rate of the lidar.

### Lidar Detection System

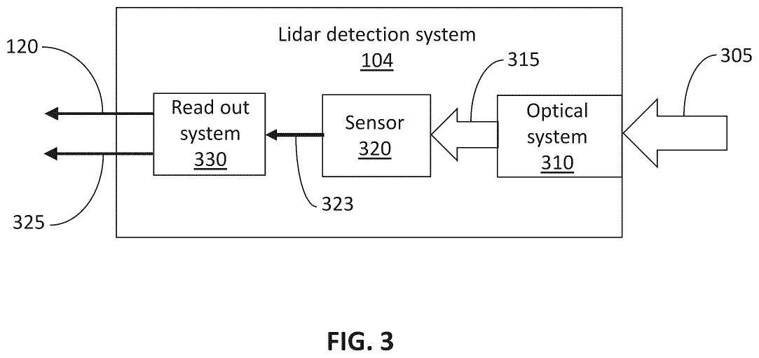

FIG. 3 is a block diagram illustrating an example detection system 104 of a lidar system (lidar). In some cases, the detection system 104 can be the detection system of ToF lidar. In some embodiments, the detection system 104 (also referred to as “detection system”) may comprise an optical system 310, a sensor 320 that converts light to electric signals, and a readout system 330. The sensor 320 may comprise different types of elements for converting light to electric signals, e.g., Avalanche photodiodes (APD), Silicon Photo multipliers (SiPM), arrays of single-photon avalanche diodes (SPAD arrays), or other types. The optical system 310 may direct received light 305 (e.g., a reflected optical beam) received from the environment through the FOV of the detection system 104 toward the sensor 320. In some cases, the FOV of the optical system 310 can be the FOV of the detection system 104. The sensor 320 may have a plurality of elements (pixels), dedicated to different or same FOV. The sensor 320 may generate a plurality of sensor signals 323 upon receiving the sensor beam 315 from the optical system 310. The readout system 330 may receive the plurality of sensor signals 323 and generate a return signal 120 (also refer to as an “event signal”) indicating a “event” (detection event). The return signal 120 can be usable for determining the presence of an object in the environment, determining reflectivity of the object, and estimating a distance between the lidar and the object. In some cases, a return signal can be signal (e.g., a digital signal) indicative of the optical power and an arrival time of an optical signal (e.g., a reflected optical signal). In some cases, a return signal can be analog signal (e.g., an amplified copy of a sensor signal). In some cases, the return signal can include the reflectivity info of object surface based on the received optical power and the estimated distance of the object.

In some cases, received light 305 may include light associated with one or more optical probe beams emitted by the lidar. In some examples, the optical system 310 may be configured to collect, transform, and redirect received light 305 to generate the sensor beam 315 that illuminates at least a region of the sensor 320. In some examples, the optical system 310 may comprise optical elements (e.g., controllable optical elements such as lenses, mirrors, prisms, and the like) that can be reconfigured to tailor the sensor beam 315 and thereby the illuminate selected regions of the sensor 320. For example, the sensor 320 may include a plurality of integrated micro-mirrors and micro-lenses that can be controlled using electric signals. In some cases, the controllable optical elements may allow controlling the FOV of the optical system 310 and/or the sensor beam 315. As such, in some cases, the optical system 310 may be used to select received light 305 and selectively direct a portion of received light 305 to a selected portion of the sensor 320. In some cases, the optical system 310 may transform a wavefront of the received light 305 to generate the sensor beam 315.

The sensor 320 may comprise a plurality of pixels each configured to generate one or more sensor signals upon being illuminated by light received from the optical system 310. The optical system 310 may be reconfigured to direct all or a portion of the light received via its FOV on all or a portion of pixels of the sensor 320. In some implementations, the sensor 320 may generate a plurality of sensor signals 323 where each sensor signal of the plurality of sensor signals is generated by one or more pixels of the sensor 320. In some cases, a pixel may include plurality of microcells. In some cases, a pixel may comprise a plurality of sub-pixels where a sub-pixel comprises two or more microcells. Each microcell may comprises an array of single-photon avalanche diode also known as a SPAD array. In some such cases, the sensor signal generated by the pixel may comprise a sum of the sensor signals generated by all or a portion of the microcells or subpixels of the pixel. In some cases, one or more microcells or subpixels may include an optical filter (e.g., a near-IR narrowband optical filter) that filters light received by the microcell or subpixel. Different microcells or subpixels may include optical filter having the same or different spectral response.

In some cases, the pixels of the sensor 320 may be configured to detect low intensity light associated with reflection of an optical probe beam generated by the lidar. In some cases, a pixel may comprise a silicon photomultiplier (SiPM) and the corresponding sensor may be referred to as a SiPM-based sensor. A SiPM-based sensor may can be configured as a single pixel sensor or an array of pixels. A microcell or a sub-pixel of a M-based sensor may comprise a SPAD. A SiPM-based sensor can be an optical detector that senses, times, and quantifies light (or optical) signals down to the single-photon level. In some examples, a SiPM-based sensor may include a series combination of microcells and a photodiode (a reference photodiode). A SiPM pixel may include a plurality of microcells in an array that share a common output (e.g., anode and cathode). In an embodiment, each microcell is a series combination of a single-photon avalanche photodiode (SPAD) and a quenching circuit (e.g., resistor or transistor). All of the microcells may be connected in parallel and detect photons independently. In some embodiments, SiPM-based sensor can include one or multiple SiPM-based pixels, which can detect photon or optical return signals independently. The quenching circuit may lower a reverse voltage applied to the SiPM to a value below its breakdown voltage, thus halting the avalanche of current. The SiPM then recharges back to a bias voltage, and is available to detect subsequent photons. In some cases, all of the subpixels included in a pixel, may be connected in parallel and detect photons independently.

In some embodiments, the SiPM-based sensor operates by read outs both from the photodiodes and the microcells to produce dual output signal via two separate anodes. In some embodiments, the output of the SiPM-based sensor is a continuous analog output (e.g., current output). In this manner, the current output of the plurality of pixels of the SiPM can be received and processed in parallel (e.g., by a readout circuit). In some embodiments, the output of the SiPM-based sensor comprise individual pulses that are distinguishable and thus can be counted (e.g., digital output). The pulses output by the SiPM may counted to generate an output signal. The output of the SiPM-based sensor according to the present techniques enables the generation of signals within a dynamic range from a single photon to hundreds and thousands of photons detected by the micro-cells and the photodiodes. In some cases, micro-cells and could have different optical filters, e.g., photodiodes having broadband filters and microcells having a near-infrared (NIR) filters (e.g., narrow band filters).

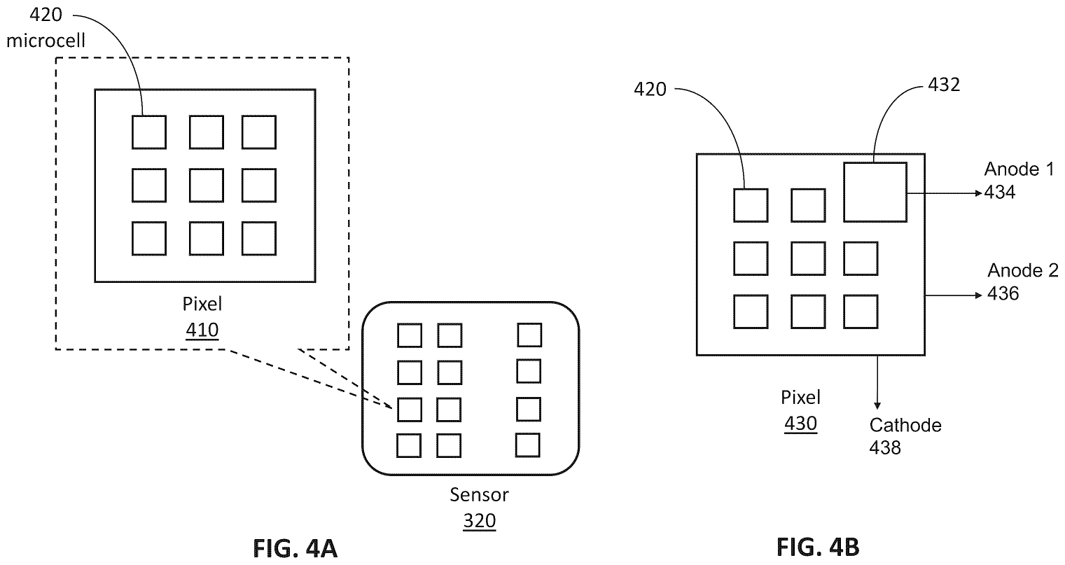

FIG. 4A is a diagram illustrating an example sensor 320 of a lidar detection system (e.g., detection system 104) and a close-up view of a pixel 410 (e.g. SiPM pixel) of the plurality of pixels that may be included in the sensor 320. As described above, the pixel 410 may include a plurality of microcells, or subpixels where a subpixel comprises two or more microcells (e.g., interconnected microcells). In some cases, the plurality of microcells or subpixels may be of the same or different types. For example, a pixel may include one or more photodiode (PD) type subpixels and one or more microcells or subpixels comprising SPADs. In some examples, a microcell or subpixel may comprise a filter configured to allow light having a wavelength within a passband of the filter to be detected by the microcell or subpixel while rejecting light having a wavelength outside of the passband.

In some cases, one or more subpixels (e.g., SPAD type or PD type) of the sensor may comprise a broadband filter that allows light having a wavelength range outside of the operating wavelength range of the lidar, to be detected. In some such cases, the one or more subpixels that comprise a broadband filter may be used to measure background light received by the optical system 310. In these cases, the one or more subpixels may be referred to as reference subpixels. FIG. 4B is a diagram illustrating an example sensor of a lidar detection system (e.g., detection system 104) that includes a reference subpixel 432. In some cases the reference subpixel 432 can be a photodiode (PD) and the other microcells or subpixels (e.g., microcell 420), can be SPADs. In some embodiments, the pixel 430 may produce dual outputs including an output signal generated by the reference subpixel 432. In these embodiments, the pixel 430 may have a first anode 434 connected to the reference subpixel 432 and a second anode 436 outputting signals associated with all or a portion of other microcells, or subpixels.

In various embodiments, a pixel can be a SPAD array. One or more SPADs (e.g. gate, transfer, or control transistors), may provide individual sensor signals to the readout system 330. In some examples, one or more SPADs, may provide a single combined sensor signal to the readout system 330. In some cases, the sensor signals generated by the reference subpixels that include broadband filters may be individually provided to the readout system 330. In some such cases, the photocurrents generated by the reference subpixels may be combined (e.g., summed) and provided to the readout system 330 as a single signal.

In some cases, a reference subpixel may include an optical filter that rejects received light having a wavelength within an operating wavelength range of the lidar or within the passband of optical filters included in other subpixels or microcells. In some cases, a reference subpixel may include a broadband optical filter that allows light having a wavelength within and outside an operating wavelength range of the lidar to reach the microcells of the reference subpixel.

In some cases, a pixel may include a broadband optical filter that filters light received by all of its microcells and subpixels. In some such cases, such pixel may be used as a reference pixel for measuring the background light.

In some embodiments, the sensor signal 323 can be a continuous analog output (e.g., current output). In some embodiments, the sensor signal 323 may include individual pulses that are distinguishable and thus can be counted. The output of the sensor 320 according to the present techniques may enable the generation of output signals within a dynamic range from a single photon to hundreds and thousands of photons detected by the pixel.

In some cases, a broadband optical filter included in a reference sub-pixel or a reference pixel may transmit a spectral portion of sun light that is rejected by bandpass filters included in other subpixels or pixels in the sensor.

In some embodiments, all microcells of the pixel 410 or 430 may receive light from the same portion of the FOV of the optical system 310. In some cases, two microcells or two groups of microcells may receive light from two different portions of the FOV of the optical system 310. In some embodiments, all pixels of the sensor 320 may receive light from the same portion of the FOV of the optical system 310. In some cases, two pixels or two groups of pixels may receive light from two different portions of the FOV of the optical system 310.

In various implementations, bias voltages applied on the microcells or subpixels of a pixel may be controlled individually. For example, one or more microcell or subpixels may be biased at higher or lower voltage compared to the other microcell or subpixels. In some cases, the individual output signals received from the microcell or subpixels of a pixel may be summed by the readout system 330 to determine the output signal for the pixel. In some embodiments, the bias voltage applied on a microcell or subpixel may be controlled based at least in part on a background signal indicative of a level or an amount of background light received by the microcell or subpixel.

### Generating Return Signals

In some cases, the readout system 330 may include a readout circuit configured to receive and process the one or more sensor signals 323 from the sensor 320. In some cases, the readout circuit may generate one or more return signals using the one or more sensor signals 323. In some cases, a return signal may be generated by a sensor signal received from a single pixel of the sensor 320. In some cases, the readout circuit may use a sensor signal received from a pixel and generate a return signal indicative of the optical power of and the arrival time of an optical signal (e.g., a reflected optical signal) received by the pixel via the optical system 310. In some other cases, the readout circuit may use a plurality of sensor signals received from a group of pixels and generate one or more return signals indicative of the optical power of and the arrival time of an optical signal (e.g., a reflected optical signal) received by the group of pixels via the optical system 310. In some cases, the readout circuit may determine the rise time, peak time, peak value, area, and the temporal shape of the optical signal based on the one or more sensor signals. In some examples, power and timing calculations can be based on edge, peak, and shape of the optical signal.

In some cases, the signal processing system of a lidar (e.g., a ToF lidar) may use the arrival time of the photons received by one or more pixels to calculate a distance between an object by which the photons were reflected and the lidar. In some cases, the signal processing system of a lidar (e.g., a ToF lidar) may use the arrival time of the photons received by one or more pixels to calculate a distance between an object by which the photons were reflected and the lidar. In some cases, the signal processing system may additionally use a temporal behavior (e.g., shape) of sensor signals received from the sensor 320 to determine the distance.

In various implementations, the readout system 330 may use a sensor signal to determine the arrival time and the shape of an optical signal using different methods including but not being limited to: time-to-digital conversion (TDC), peak finding, and high bandwidth analog to digital conversion.

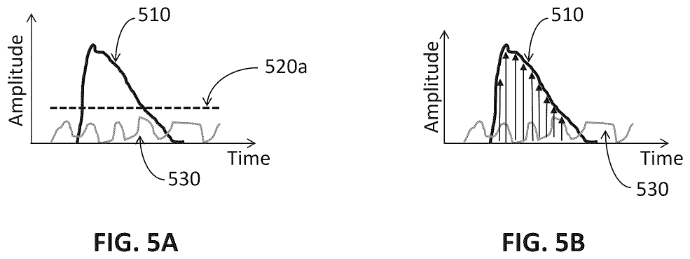

FIGS. 5A-5B are diagrams illustrating the temporal profile of the sensor signal 323 generated by a pixel of the sensor 320 measured using two different methods. In these diagrams, the signal component and the noise component of the sensor signal are shown separately to facilitate the description of the corresponding background estimation methods. In the examples shown, the signal component 510 of the sensor signal (e.g., a photocurrent) can be a portion of sensor signal generated by light associated with reflection of an optical probe signal emitted by the lidar, and the background (noise) component 530 can include a portion of sensor signal generated by the background light received by the pixel.

In the example shown in FIG. 5A, the readout system may use at least one threshold level (a readout threshold level) 520a to determine an arrival time and/or the optical power of the optical signal received by the corresponding pixel based on time-to-digital (TDC) conversion, and to generate a return signal.

In the examples shown in FIG. 5B the readout circuit may use high bandwidth (e.g. 1 GHz) ADC to convert the sensor signal to a digital signal. Subsequently, the readout circuit may determine an arrival time and/or the optical power of the optical signal received by the corresponding pixel based using the resulting digital signal.

In some cases, the readout system may use various processing methods (e.g., peaking finding, pulse shape fitting, threshold, and the like) to process the sensor signal. These methods may be implemented using machine-readable instructions stored in a non-transitory memory of the readout system.

In various implementations, any of the method described above may be implemented (e.g., by the readout system 330) to measure sensor signals received from a pixel during one or more measurement time windows (also referred to as measurement windows). In some cases, the measurement window can be a predefined time window. In some cases, the readout system may use the same or different time windows during different measurement time intervals or for different pixel and or different scanning FOVs.

In some embodiments, the readout system may periodically use a first time window to measure the sensor signals received during a first measurement time interval and a second time window to measure the sensor signals received during a second measurement time interval.

As indicated in FIG. 5A-5B at each point in time the sensor signal generated by individual pixels includes a noise component that will be measured along with the signal component. In some cases, the noise component may reduce the accuracy of the resulting return signal. For example, if the magnitude of the noise component is comparable with the magnitude of the signal component, the readout system may determine an arrival time that at least partially is associated with the noise component. In some cases, when the power or intensity of background light becomes larger than reflected light associated with an optical probe signal, the readout system may completely miss the signal component and may not generate any return signal.

Various designs and method disclosed herein may be used to improve the signal-to noise-ratio of sensor signals generated by a pixel or a group of pixels, and therefore increase the accuracy and reliability of the corresponding return signals. In some cases, the disclosed methods and system may improve the signal-to-noise ratio of the return signal.

Some of the methods and systems described below may provide a confidence signal indicative of the probability of a return signal to be associated with a reflected optical signal resulting from the reflection of an optical probe signal emitted by the lidar.

Detection System with Pixel Based Background Light Measurement

As described above, the background light generated by various optical sources in an environment scanned and monitored by a lidar system, may increase the noise level and false alarm rate of the lidar system.

In some cases, background light having nearly constant or a slowly varying magnitude (e.g., slowly varying power or intensity), may decrease the signal-to-noise ratio (SNR) of the sensor signals 323 generated by the lidar sensor and/or the resulting return signals. In some cases, when the lidar signal processing system 106 uses sensor signals and/or return signals for determining the presence of an object in the environment and its distance from the lidar, lower signal-to-noise-ratio of the sensor signals and/or return signals results in higher probability of falsely indicating the presence of the object, or reduced accuracy of the determined distance.

In some cases, when the background light includes optical pulses or when its magnitude varies at a relatively high speed (e.g., for example background light generated by another lidar as described with respect to FIG. 1B), the readout system may falsely identify the sensor signals generated by the background light as sensor signals generated by reflected optical signals associated with the optical probe signals emitted by the lidar. As such, the light generated by other lidars in the environment may interfere with the operation and more specifically with the detection and range finding function of the lidar.

In some cases, the detection system may quantify the amount of background light received by the detection system dynamically control optical system, sensor, and readout circuit to improve SNR of the return signals, mitigate interference with other optical systems, and in general reduce the impact of the background light on the performance of the lidar system. In some cases, quantifying the amount of background light received may include generating background signals indicative of the level of background light received by a sensor of the detection system or by the pixels in the sensor.

In various implementations, the detection system may generate a background signal indicative of an amount of background light received by a pixel or a group of pixels in a sensor, and use the background signal improve the detection probability and to reduce the false alarm rate, improve the accuracy of the return signals, or at least quantify a confidence level of the return signals generated based on the sensor signals received from the sensor.

In some cases, the detection system may use the background signals to reduce the background noise associated with slowly varying or constant background light, by dynamically controlling the optical system, the sensor, and/or the readout system of the lidar in order to reduce the contribution of background light in generating the return signals. For example, the detection system may use the background signals to: reduce the amount of background light directed to the sensor, switch off one or more pixels that receive excessive amount of background light, eliminate sensor signals received from a portion of the sensor that receives excessive amount of background light, or adjust a threshold level used to distinguish portions of a sensor signal associated with background noise and optical signal. In some case, the threshold level may comprise a voltage provided by a discrete electrical component, or a current provided by an application-specific integrated circuit (ASIC).

In some cases, when the background light includes optical pulses or its magnitude varies at a relatively high speed, the detection system may use the background signals to generate a confidence signal for one or more return signals. A confidence signal may indicate a probability that a return signal generated by a light associated with an optical probe signal emitted by the lidar and received by the lidar detection system 604 via a straight optical path from an object. In some implantations, the event validation circuit 610 may generate a confidence signal for a return signal by determining a level of background light received by the sensor 320 in a period during which the return signal is generated.

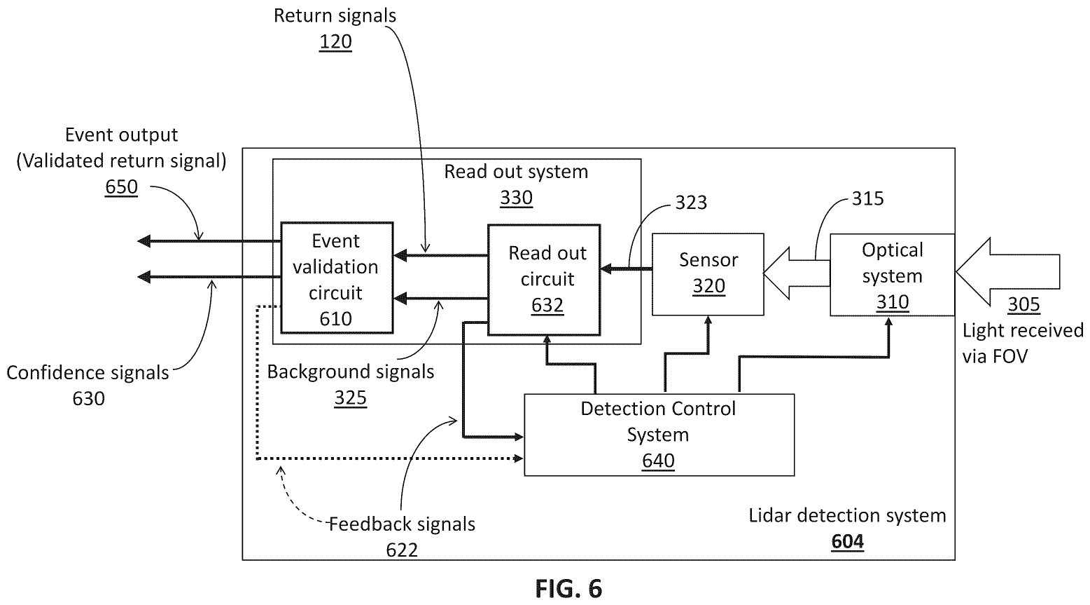

FIG. 6 is a block diagram illustrating an example of a lidar detection system 604 (or detection system 604) that may generate and use background signals 325 and use them to improve SNR of the return signals return signals 120, improve SNR of the return signals return signals sensor signal 323, and/or generate confidence signals 630. In some examples, one or more background signals 325 may be associated with individual pixels of the sensor 320.

In some implementations, similar to the detection system 104, the detection system 604 may include an optical system 310, a sensor 320, and a readout system 330. In some cases, the readout system 330 may include a readout circuit 632 and an event validation circuit 610. Additionally, in some examples, the detection system 604 may include a detection control system 640 configured to control the readout circuit 632, the sensor 320, and/or the optical system 310 based at least in part on a feedback signals 622 received from the readout circuit 632 or the event validation circuit 610. In various implementations, the detection system 604 may not include one of the detection control system 640 or the event validation 610. In some cases, the readout circuit 632 or the event validation circuit 610 may generate the feedback signals 622 based at least in part on the background signals 325. In some cases, a feedback signal may carry information usable for controlling the optical system 310, the sensor 320, and/or the readout circuit 632 in order to improve the signal-to-noise ratio of the sensor signals 323 generated by the sensor 320 and/or the return signals 120 generated by the readout circuit 632.

In some cases, a feedback signal may indicate a distribution of ratios between individual return signals and background signals associated with pixels of the sensor 320.

In some examples, the detection control system 640, may use the one or more feedback signals 622 to improve the SNR of sensor signals 323, and/or the return signals 120 generated by the readout circuit, by controlling the optical system 310, the sensor 320, and/or the readout circuit 632.

In some implementations, the optical system 310 may direct a portion of light incident on an input aperture of the optical system 310 to the sensor 320. The portion of light directed to the sensor 320 may include light incident on the input aperture along directions within a field of view (FOV) of the optical system 310. In some cases, the optical system 310 directs a portion of light received via the input aperture to illuminate a portion of the optical system 310. In some cases, the detection control system 640 may control the FOV and/or the illuminated portion of the sensor. In some cases, the detection control system 640 may use the feedback signals 622 to identify a portion of the FOV from which the amount of background light is received exceeds a threshold level and dynamically adjust the FOV of the optical system 310 to reduce the amount of background light received. Alternatively or in addition, the detection control system 640 may adjust the optical system 310 such that the portion of light, received via the FOV, that includes a level of background light larger than a threshold level, is not directed to the sensor (e.g., is filtered out). As such, the detection control system 640 may reduce the amount of background light reaching the sensor 320 by controlling the optical system 310 and thereby improve the SNR of the return signals. The event validation circuit 610 may determine the level of background light using the background signals 325.

The sensor 320 may generate a plurality of sensor signals 323 (e.g., electric signals, such as photovoltages, photocurrents, digital signals, etc.) and transmit the sensor signals to the readout system 330. In some cases, the readout circuit 632 of the readout system 330 generate feedback signals 622, return signals 120, and/or background signals 325, based at least in part the sensor signals 323 received from the sensor 320. In some examples, a return signal may indicate reception of a reflected optical signal by the optical system 310 and a background signal may indicate background light (e.g., a magnitude of the background light) received by one or more pixels of the sensor 320 or one or more subpixels of a pixel of the one or more pixels.

In some cases, the readout circuit 632 may transmit return signals 120 and the background signals 325 to the event validation circuit 610. In some examples, the event validation circuit 610 may generate one or more confidence signals 630 using the return signals 120 and the background signals 325. In some such cases, the lidar detection system 604 may not include the detection control system 640. In various implementations, a confidence signal may indicate a probability that a return signal generated by the readout circuit 632 is associated with an optical probe signal emitted by the lidar. In some cases, a confidence signal may indicate a probability that a return signal generated by the readout circuit 632 is not associated with optical probe signals and/or the corresponding reflected optical signals emitted by another lidar or another source of light. In some examples, the confidence signal may indicate that within a period during which the one or more return signals were received, the level of background light received by the sensor (e.g., a portion of sensor that provides the sensor signals from which the return signals are generated), exceeded a threshold level (a predetermined level).

In some cases, the event validation circuit 610 may generate a confidence signal for one or more return signals based at least in part on a confidence ratio between a number of pixels that have received background light below the threshold level and a number of pixels that have received background light above the threshold level during the period that the return signal was generated. In some cases, the number of pixels may be determined based on a portion of the pixels that contribute in the generation of the return signal. In some cases, the event validation circuit 610 may use the background signals received from the pixels that contribute in the generation of the return signal to determine the confidence ratio.

In some cases, the event validation circuit 610 may generate a confidence signal for one or more return signals based at least in part on detected background light, or signal-to-noise ratio of the return signal.

In some examples, the return signals and the corresponding confidence signals may be generated for the sensor 320 or a pixel of the sensor 320 during a given measurement time interval. In some cases, the event validation circuit may first generate individual confidence signals for the each detected event, and use the individual confidence signals to generate an overall confidence signal for individual pixels the given measurement time interval. In some cases, the event validation circuit may first generate individual confidence signals for the individual pixels or groups of pixels, and use the individual confidence signals to generate an overall confidence signal for the sensor the given measurement time interval. In some cases, the measurement time interval for which a confidence signal is generated may include one or more measurement time windows (herein referred to as “measurement windows”). The event validation circuit 610 may transmit the confidence signals 630 and, in some cases, the corresponding return signals 120, to the lidar signal processing system 106 for further processing and determination of the presence of an object in an environment scanned by the lidar and calculating the distance and/or the velocity of the object with respect to the lidar or another reference frame. In some cases, the lidar signal processing system 106 may receive the confidence signals 630 from the event validation circuit 610, and the return signals 120 from the readout circuit 632. In some examples, the lidar signal processing system 106 may process the return signals that are associated with confidence signals indicating that the probability of return signals being falsely generated is below a threshold probability.

In some cases, the readout circuit 632 may generate individual background signals for individual pixels, or a background signal for a group of pixels of the sensor 320. In some cases, the readout circuit may generate a background signal for a pixel using sensor signals generated by the pixel during one or more measurement time windows (measurement windows). In some cases, the readout circuit 632 may generate a return signal and a background signal using a sensor signal received from a pixel during the same measurement window, or different measurement windows. In some cases, a background signal may indicate the amount of background light received by a pixel during a measurement window. In some cases, a pixel or subpixel (e.g., a reference pixel or a reference subpixel) of the sensor 320 may be dedicated to generation of a background signal. In some such cases, the readout circuit 632 may use a sensor signal received from the reference pixel or subpixel to generate a background signal for sensor signals generated by the sensor 320 (or one or more pixels of the sensor 320). The background signal and the sensor signals generated by the sensor 320 (or one or more pixels of the sensor 320) may be generated at the same measurement time interval or same measurement window.

In some cases, the readout circuit 632 may generate background signals for a pixel, using sensor signals generated by one or more subpixels of the pixel during one or more measurement windows. In some cases, the readout circuit may generate a return signal and a background signal using a sensor signal received from the subpixel during the same measurement window, or different measurement windows. In some cases, individual background signals may be generated for individual pixels. In some cases, one or more subpixels (e.g., a reference subpixel) of a pixel may be dedicated to generation of a background signal.

In some implementations, the background signals may be used in various applications, including but not limited to adaptive control of the lidar detection system, improving the SNR of sensor signals, and mitigation of interference with other lidar systems.

In some cases, a reference. sub-pixel or a reference pixel that is dedicated to measurement of background light, may include a broadband optical filter that allows light having a wavelength different from the operating wavelength of the lidar to be detected by the subpixel. In some cases, the sensor signal generated by a reference sub-pixel may be measured at selected time windows that do not correspond to reception of a reflections of optical probe signals. As described above a reference sub-pixel may have an anode separate from the anodes of other subpixels of the pixel.

In some cases, the background signals 325 may be generated by measuring the sensor signals (e.g., output currents) during measurement windows that do not include a sensor signal variation associated with the reflection of an optical probe signal generated by the lidar.

Advantageously, generating a background signal indicative of real-time or nearly real-time background noise separately for each pixel during a measurement time interval, may be used to improve the accuracy of the return signals generated by the pixel.

In some cases, the readout circuit 632 may generate a background signal for a pixel of the sensor 320 based at least in part on the sensor signals generated by other pixels of the sensor 320. In some such cases, the other pixels may be pixels adjacent to the pixel for which the background signal is generated.

In some examples, a background signal indicates the amount of background light received by a pixel or a subpixel within a time frame during which a reflected optical signal is received by the pixel or the subpixel.

In some cases, the feedback signals 622 may comprise at least a portion of the background signals 325. In some cases, the readout circuit may first generate the background signals 325 and then generate the feedback signals 622 using the background signals 325. For example, the readout circuit may use the background signals 325 to identify one or more pixels of the sensor 320 that each generate a background signal having a magnitude larger than a threshold (e.g., threshold magnitude) and generate a feedback signal (e.g., indicative of pixel coordinates, pixel locations, or pixel identifiers) that may be used by the detection control system 640 to modify a configuration of optical system 310, sensor 320, and readout system 330. In some cases, the detection control system 640 may improve the SNR of the return signals 120 by turning off the pixels that have generated a background signal larger than a threshold value. In some cases, the detection control system 640 may improve the SNR of the return signals 120 by reducing the contribution of the pixels that have generated a background signal larger than a threshold value and/or increasing the contribution of the pixels that generate a background signal lower than a threshold value. In some such cases, the feedback signal may include information usable for identifying the pixels that generate a background signals above or below the threshold value.

In some cases, the feedback signals 622 may be generated by the event validation circuit based at least in part on the confidence signals 630. For example, the event validation circuit 610 may identify one or more pixels of the sensor 320 that have a larger contribution in reducing the probability of a return signal to be associated with an optical probe signal emitted by the lidar. As another example, the event validation circuit 610 may identify one or more pixels of the sensor 320 that have the high probability of the received light associated with interference signals (e.g., ambient light or another lidar system.

In some implementations, in addition to the feedback signals 622, the detection control system 640 may receive the return signals 120 from the readout circuit 632 and control the detection system based at least in part on the return signals 120.

In some cases, the event validation circuit may generate an event signal 650 indicative of an event detected by the lidar detection system 604.

In some implementations, the readout circuit 632 may include a channel readout circuit that generated the return signals 120 and a background monitor circuit that generated the background signals 325.

In some implementations, the readout circuit 632 may generate the return signals 120 and the background signals 325 by measuring the sensor signals received during a measurement time interval. In some cases, the measurement time interval may include a plurality of measurement windows during which the sensor signal is analyzed to find a temporal variation of the sensor signal amplitude that may be associated with a reflected optical signal. In some cases, the readout circuit may use one of the methods described above with respect to FIG. 5, to analyze and measure the sensor signals received during a measurement window and search for a peak and determine the corresponding peak amplitude level and/or peak time. In some cases, during an analysis, the readout circuit 632 may use one or more threshold levels to identify and/or estimate the peak and/or the corresponding peak amplitude level and/or peak time. In some cases, the readout circuit 632 may use a single measurement window during a measurement time interval. In some cases, the readout circuit 632 may use two or more measurement windows during measurement time interval. In some such cases, the readout circuit 632 may change the measurement window over one or more measurement time intervals to identify a portion of the sensor signal or pixel output associated with background light received by the corresponding pixel or subpixel (one or more microcells), and a generate background signal indicative of a magnitude of the background light. In some cases, the readout circuit 632 may select a measurement window during which the magnitude of the background light is measured based on one or more measurement windows during which a return signal has been generated. For example, the readout circuit 632 may measure the magnitude of the background light during a measurement window that is delayed by a set delay time with respect to a measurement window during which a return signal has been generated.

In some cases, the detection control system 640 may use the feedback signals 622 to adjust one or more parameters of the readout circuit 632 to improve the SNR of the return signals 120 generated by the readout circuit 632. In some cases, the detection control system 640 may reduce the contribution of background noise in the sensor signals used to generate return signals, by selecting (using the feedback signal) a subset of pixels used for generating a return signal and reducing the contribution of the pixels of the subset that generate excessive background noise when generating the subsequent return signals. For example, the detection control system 640 may use the feedback signal generated in a first measurement time interval, during which a first return signal is generated, to identify pixels or sub-pixels of the subset of pixels that generate background signals having magnitudes larger than a threshold level and adjust the readout circuit 632 to reduce the contribution of the sensor signals received from the identified pixels or sub-pixels (herein referred to noisy pixels or noisy sub-pixels), in generation of a second return signal during a second measurement time interval after the first measurement time interval. In some cases, reducing the contribution of one or more pixels or sub-pixels in generation of the second return signal may comprise not using the sensor signals generated by these pixels for generating the second return signal. In some implementations, the first and second measurement time intervals may be subsequent time intervals. In some examples, the second return signal may be a subsequent return signal generated after the first signal in less than 1 picoseconds, less than 1 nanosecond, less than 1 microsecond, or less than 1 millisecond.

In some cases, the detection control system 640 may use the feedback signals 622 to adjust one or more parameters of the readout circuit 632 to improve the detection probability of the object while reduce or maintain the FAR of the lidar detection system 604, with respect to a reference FAR level. In some such cases, the readout circuit 632 may increase the probability of detection (PoD) by dynamically adjusting a readout threshold of the readout circuit 610. For example, when during one or more measurement time intervals the background signals associated with a pixel are larger than a threshold value, the detection control system 640 may increase the readout threshold for that pixel. In some cases, increasing the readout threshold for that pixel may reduce the probability of background noise generated by the pixel to be identified as sensor signal associated with a reflection of an optical probe signal emitted by the lidar.

In some cases, the readout threshold may comprise a sensor signal threshold level (also referred to as readout threshold level) used to distinguish a portion of a sensor signal generated by the reflected light associated with an optical probe signal emitted by the lidar, from a portion of the sensor signal generated by the background light.

In some cases, the FAR (false alarm rate) of the lidar detection system 604 may comprise a rate of generation of return signals that are not associated with a reflection of an optical probe signal emitted by the lidar.

In various implementations, the readout circuit 632, the detection control system 640, and the event validation circuit 610 can be programmable circuits and may include a memory and one or more processors configured to execute computer-executable instructions stored in the memory. Accordingly, various functions, procedures and parameter values (e.g., various threshold values) described above with respect to generation of confidence signals and dynamically controlling the lidar detection system to improve SNR of the return signals 120, and/or reducing the FAR of the lidar detection system 604 may be implemented and controlled by modifying the computer-executable instructions executed by different circuits and systems. For example, the detection control system may be programed to control the readout circuit 632, sensor 320, and/or the optical system 310 based on threshold values stored in a memory of the detection control system 640.

In some implementations, the readout circuit 632 may use a plurality of background signals to generate a sensor background signal and use a plurality of return signals to generate a return signal. In some examples, increasing the probability of detection of the lidar system may compromise decreasing FAR. In some cases, improving or increasing the SNR of the return signals 120 and/or sensor signals 323 may compromise increasing a ratio between the return signal and the sensor background signal. In some examples, the sensor background signal may comprise a sum of the plurality of background signals, and the return signal may comprise a sum of the plurality of return signals.

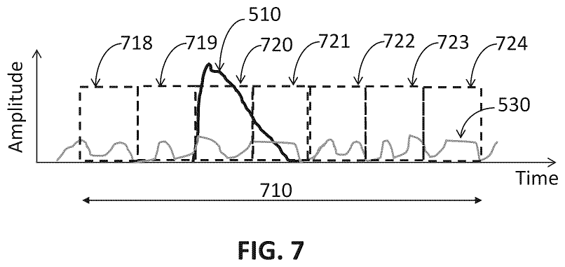

FIG. 7A is a diagram illustrating sensor signal received from a pixel during a measurement time interval 710, and background light measurement based on multiple measurement time windows. To facilitate the description, signal component 510 and background (noise) component 530 of the sensor signal are plotted separately. The sensor signal could be analog signal (e.g. analog current) or digital signal (e.g. digital voltage or current level). In the example shown, the measurement time interval 710 is divided into several measurement windows where during one or more of the measurement windows (measurement window 720, 721) a signal peak is detected. In some cases, light received during the measurement windows 718, 719, 722, 723, and or 724, may be measured to generate a background signal indicative of an amplitude of the background component 530. In some cases, the background signal generated based on sensor signal received during the measurement window 718 or 724 may be used as a background signal during the measurement time interval shown in FIG. 7A. In some cases, the background signal may be generated using the portions of the sensor output received during the measurement window 722, 723, and 724 (e.g., by calculating an average of the corresponding signals). In some cases, the background signal generated for the measurement time interval shown in FIG. 7A may indicate a magnitude (e.g., an average magnitude) of background light having a nearly constant or slowly varying power or intensity (e.g., sun light, or light generated by another source).

In some cases, the background signal generated for a pixel based on a measurement time interval may be used to reduce the background signals generated for the pixel during subsequent measurement time intervals or time windows. In some cases, the readout circuit 632 may generate a background signal based on the background signals generated for one or more pixels of the sensor 320 during a measurement time interval or time window and use the background signal to adjust the sensor 320, optical system 310, or the readout circuits 632 in real-time to reduce background signals in subsequent measurement time intervals.

In some cases, the readout circuit 632 may generate a feedback signal based on a first background signal generated for the sensor 320 using sensor signals received during a first measurement time interval. In some such cases, the detection control system 640 may use the first background signal to control the sensor 320, and/or the optical system 310 such that a second background signal generated for the sensor 320 using sensor signals received during a second measurement time interval after the second measurement time interval, is smaller than the first background signal. As such, sensor signals and a corresponding second return signal generated during the second time interval, may have a larger signal-to-noise ratio compared to sensor signals and a corresponding first return signal generated during the first time interval. In some examples, the second return signal may be a subsequent return signal generated after the first signal in less than 1 picoseconds, less than 1 nanosecond, less than 1 microsecond, or less than 1 millisecond. In some cases, the first measurement time interval can be a subsequent measurement time interval after the first measurement time interval. For example, the detection control system 640 may use the feedback signal to determine the sensor signal generated by which pixels of the sensor 320 had a lager contribution in the first background signal and turn off those pixels in the second measurement time interval. In some cases, a lager contribution in a background signal generated for a sensor may be determined by determining that the background noise (sensor signal associated with background light) received from a pixel of the sensor is larger than a threshold value. In some cases, the threshold value can be a percentage of the background signal (e.g., 5%, 10%, 30%, 50%, 80% or larger). Alternatively of in addition, the detection control system 640 may use the first background signal to control the readout system 632, such that return signals generated sensor signals received during a second measurement time interval, have a larger signal-to-noise-ratios. For example, the detection control system 640 may use the feedback signal to determine first background signal and the threshold current level (also referred to as event validation level) used by the readout circuit 632 during the first measurement time interval and adjust the threshold current level during the second measurement time interval after the second time interval, to reduce the second background signal. In some examples, the second time interval can be a subsequent time interval after the second time interval.

In some embodiments, the background signal and the feedback signal could be used to control readout circuit (e.g., by controlling a threshold level), sensor (e.g., by activating or deactivating pixels, or changing a pixel group size), optical system (e.g., by changing the field of view).

In some cases, the readout circuit 632 may generate a feedback signal based on real-time background signal to control the sensor 320, and/or the optical system 310. For example, the detection control system 640 may use the feedback signal to determine which pixels of the sensor 320 had a lager contribution in the background signal and turn off pixel output (sensor 320) or reduced the optical transmission (optical system 310) of those pixels. In some cases, a lager contribution in a background signal generated from one or some pixels may be determined by determining that the background noise received from these pixel is larger than a threshold value.

In some embodiments, the detection control system 640 may use the background signal to control the readout system 632, such that signal readout and event output, have a higher probability of detection. For example, the detection control system 640 may use the feedback signal to determine the threshold level used by the readout circuit 632 and adjust the threshold level of event determination to maintain a reasonable FAR. In various implementations, individual background signals that indicate the intensity and temporal profile of background light received by individual pixels of the sensor 320, may be used by the event validation circuit 610 to generate a confidence signal for the return signals generated by the readout circuit 632 during the measurement time interval associated with the background signals.

Example Lidar System with Feedback Control

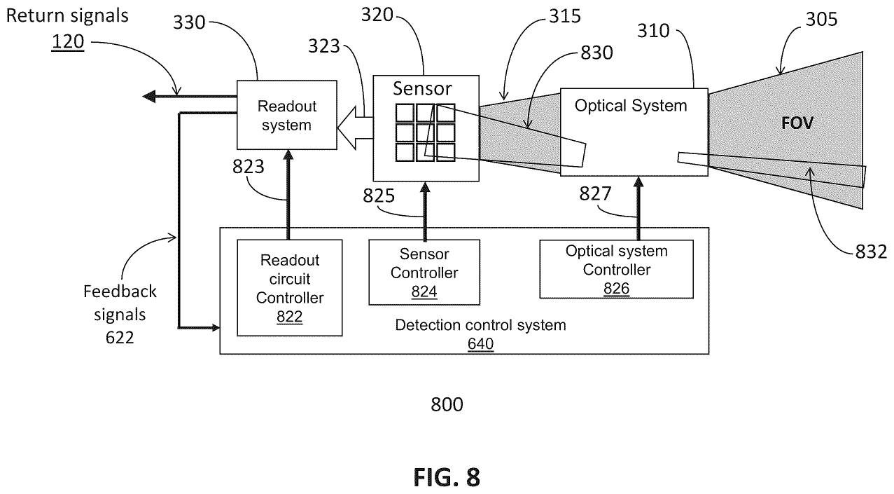

FIG. 8 illustrates an example lidar detection system 800. In some cases, lidar detection system 800 can be an embodiment of the lidar detection system 604 having a detection control system 640. In the example shown, the detection control system 640 includes a readout circuit controller 822 that controls the readout system 330, a sensor controller 824 that controls the sensor 320, and an optical system controller 826 that controls the optical system 310. As described with respect to FIG. 6, the detection control system 640 may receive feedback signals 622 from the readout system 330 and use the feedback signals to dynamically control the detection control system 640 to reduce the contribution of the background light in the return signals generated by the readout system 330.

In some cases, the detection control system 640 may control the readout system 330 by generating readout system control signals 823 and transmitting them to the readout system 330. The detection control system 640 may generate the readout system control signals 823 using one or more feedback signals 622 received from the readout system 330. In some cases, the readout system control signals 823 may include command and instructions usable for selecting and controlling pixels and/or subpixels of the sensor 320 from which the return signals are generated. In some examples, the feedback signals 622 may be associated with an initial measurement time interval and the detection control system 640 may generate readout system control signals 823 that reconfigure the readout system 330 to reduce the signal-to-noise ratio and/or reliability of the return signals generated by the readout system 330 during one or more measurement time intervals after the initial measurement time interval. In some cases, reconfiguration of the readout system 330 may include adjusting the contribution of individual sensor signals generated by individual pixels or sub-pixels to the return signals. For example, the readout system control signals 823 may change a weight factor of the sensor signal generated by a pixel or a sub-pixel, in a procedure that generates a return signal using a weighted sum of the sensor signals 323.

In some cases, the detection control system 640 may control the sensor 320 by generating sensor control signals 825 and transmitting them to the sensor 320. The detection control system 640 may generate the sensor control signals 825 using one or more feedback signals 622 received from the readout system 330. In some examples, the feedback signals 622 may be associated with a first measurement time interval and the detection control system 640 may generate readout system control signals 823 that reconfigure the sensor 320 to reduce the signal-to-noise ratio and/or reliability of the return signals generated by the readout system 330 using the sensor signals 323 received from the sensor 320 during one or more measurement time intervals after the first measurement time interval. In some cases, reconfiguration of the sensor 320 may include adjusting the bias voltage applied on a pixel or a subpixel of the pixel, or turn off a pixel or a subpixel of the pixel. In some examples, a measurement time interval after the first measurement time interval can be a subsequent measurement time interval immediately after the first measurement time interval.

In some cases, the detection control system 640 may generate the sensor control signals 825 using one or more feedback signals 622 received from the readout system 330. In some examples, the feedback signals 622 may be associated with a real-time measurement and the detection control system 640 may generate readout control signals 823 that reconfigure the sensor 320 to select pixels or subpixels for next one or more measurement. In some cases, reconfiguration of the sensor 320 may include adjusting the bias voltage applied on a pixel or individual sub-pixels of the pixel, or turn off a pixel or a subpixel of the pixel.

In some cases, the detection control system 640 may control the optical system 310 by generating optical system control signals 827 and transmitting them to the optical system 310. The detection control system 640 may generate the optical system controller 826 using one or more feedback signals 622 received from the readout system 330 In some examples, the feedback signals 622 may be associated with a first measurement time interval and the detection control system 640 may generate optical system control signals 827 that reconfigure the optical system 310 to reduce the signal-to-noise ratio and/or reliability of the return signals generated by the readout system 330 during one or more measurement time intervals after the first measurement time interval. In some cases, reconfiguration of the optical system 310 may include adjusting one or more optical elements of the optical system 310 to reduce an amount of background light directed to at least a portion of pixels of the sensor 320 (e.g., by reducing a collection FOV). In some cases, the optical system control signals 827 may adjust the orientation of one or more mirrors (e.g., micromirrors), the focal length or position of one or more lenses (e.g., microlenses) to select and redirect a portion of light received from environment (e.g. a portion that includes a lower level of background light). For example, with continued reference to FIG. 8, in a first measurement time interval the optical system 310 may direct received light 305 within an FOV of the optical system 310 to illuminate nearly all pixels of the sensor 320. In some examples, the optical system 310 may transform the received light 305 to a sensor beam 315 (e.g., a convergent beam of light) that illuminate nearly all pixels of the sensor 320. In some implementations, the detection control system 640 may use the feedback signals 622 generated by the readout system 330 during the first measurement time interval to reconfigure the optical system 310 such that during a second measurement time interval, a selected portion 832 of the received light 305 via a portion of the FOV illuminates a selected portion of pixels of the sensor 320. In some examples, after reconfiguration, the optical system 310 may transform the received light 305 to a modified output beam of light 830 the selected portion of pixels of the sensor 320.

In some examples, the feedback signals 622 may be associated with real-time measurement and the detection control system 640 may generate optical system control signals 827 that reconfigure the optical system 310 to control optical collection path of each pixel or subpixel. In some cases, reconfiguration of the optical 310 may include adjusting one or more optical elements of the optical system 310 to reduce an amount of light collection FOV directed to at least a portion of pixels of the sensor 320. In some cases, the optical system control signals 827 may adjust the orientation of a number of micromirrors, the focal length, or lenses position to select and redirect a portion of light received from environment. For example, the optical system 310 can be capable of directing received light 305 within an FOV of the optical system 310 to illuminate nearly all pixels of the sensor 320. In some examples, the optical system 310 may transform the received light 305 to an output beam of light 315 (e.g., a convergent beam of light) that illuminate nearly all pixels of the sensor 320. In some implementations, the detection control system 640 may use the feedback signals 622 generated by the readout system 330 to reconfigure the optical system 310 such that a selected portion 832 of the FOV is transformed by re-configured optical system 310 to a modified output beam of light 830 which illuminate on the selected portion of pixels of the sensor 320.

In some implementations, the optical system 310 may include a spatial optical filter that does not allow light beams that do not propagate along a specified direction to reach the sensor 320. In some cases, the specified direction can be substantially parallel to an optical axis of the optical system 310. In some cases, the spatial optical filter can be a reconfigurable spatial optical filter that allows changing the specified direction using control signals. In some cases, the detection control system 640 may generate one or more optical system control signals 827 to change the specified direction of a spatial optical filter in the optical system 310 to reduce the magnitude of the background light directed toward the sensor 320. For example, the readout system 330 may use the sensor signals 323 received from the sensor 320 to identify a direction from which a larger portion of the background light is received by the optical system 310 compared to other directions associated with the FOV of the optical system 310. In some cases, the readout system 330 may generate a feedback signal indicating the identified direction and the detection control system 640 may receive the feedback signal and adjust the specified direction of the spatial optical filter to modify a portion of the received light 305 that propagates along the specified direction. In some cases, a spatial optical filter may be used to reduce or eliminate interference between the reflected optical signals associated with the optical probe signals emitted by a lidar and the optical signals associated with other lidars. For example, the spatial optical filters may be configured to block or absorb at least a portion of light beams that are emitted by other lidars. In some such cases, the readout system 330 may generate a feedback signal indicating the directions associated with light received from other lidars and the detection control system 640 may use the feedback signal to adjust the specified direction of the spatial optical filter to block at least a portion of light beams emitted by other lidars so they cannot reach the sensor 320.

In some implementations, the lidar system 614 shown in FIG. 8 may generate a confidence signal for one or more return signals generated during a measurement time interval where a confidence signal indicates the probability of the corresponding return signal being associated with a reflection of an optical probe signal emitted by the lidar system 614.

In some examples, the feedback signals 622 may be generated based on real-time measurement or evaluation of return signals 120, sensor signals 323, and/or background signals 325. Subsequently the detection control system 640 may generate sensor control signals 825, readout system control signals 823, and/or optical system control signals 827, to reconfigure or adjust the readout system 330. The sensor 320, and/or the optical system 310 to increase the signal-to-noise-ratio (SNR) of the sensor signals and/or return signals generated after the generation of the feedback signal. In some examples, the delay between generation of the feedback signal and reduction of the SNR can be less than 1 picosecond, less than 1 nanoseconds, less than 1 microseconds, or less than 1 milliseconds. As such, effectively the detection control system 640, may provide real-time or near real-time improvement of SNR and probability of true event detection for lidar detection system 604.

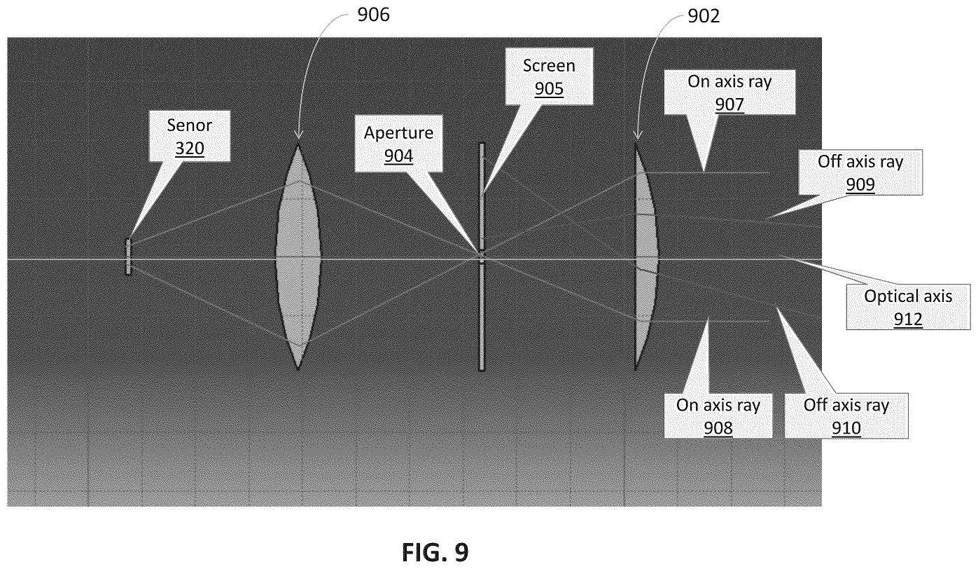

FIG. 9 illustrates an example spatial optical filter 600 that rejects light beams that do not propagate in a direction parallel to an optical axis 912 of the spatial optical filter 900. In some cases, the optical axis 912 of the spatial optical filter 900 may be parallel to an optical axis of the optical system 310. In some cases, the optical axis 912 of the spatial optical filter 900 may overlap with an axis of symmetry of the FOV of the optical system 310. The spatial optical filer 900 includes a first lens 902 (e.g., an input lens), an aperture 904, and a second lens (e.g., an output lens). The aperture 904 can be an opening in an opaque screen 905. In some examples, on axis optical rays (or beams) 907/908 that propagate in a direction parallel to the optical axis 912, may be redirected by the first lens 902 such that they pass through the aperture 904. After passing through the aperture 904, the on axis optical rays 907 and 908 may be redirected again by the second lens 906 toward the sensor 320. In some examples, off axis optical rays (or beams) 909 and 910 that propagate in along different direction than the optical axis 912, may be redirected by the first lens 902 such that they become incident on the screen 905 and are absorbed or reflected by the screen 905. As such, the optical rays 909 and 910 cannot reach the sensor 320. In some cases, the position of the aperture 904 may be controlled by the detection control system 640. In some such cases, the detection control system 640 control the position of the aperture 904 using an electromechanical or micro-electromechanical system integrated with screen 905, In various implementations, the first lens 902, the second lens 906, the aperture 904, and the electromechanical system can be on-chip components or components integrated together.

In some cases, the optical system 310 may include the spatial optical filter 900. In some cases, a spatial optical filter used in the optical system 310 may comprise one or more features described with respect the spatial optical filter 900. In some cases, the optical system 310 may include two or more spatial optical filters that filter light beams according to principles described above with respect to spatial optical filter 900.

In various implementations, a fixed or dynamically controlled spatial optical filer used in a lidar detection system may improve the signal to noise ratio of the sensor signals and return signals generated by the lidar detection system. In some cases, a fixed or dynamically controlled spatial optical filer used in a lidar detection system may reduce the amount of background light reaching the sensor, the false alarm rate of the lidar, and the interference or probability of interference with other lidar systems.

In some case, a lidar that uses a lidar detection system that comprises one or more features described with respect to the lidar detection system 604 may use one of the signal coding methods described with respect to FIG. 1C to reduce the probability of generating return signals associated with light emitted by other lidar systems. In some such cases, generation of confidence signals may further improve the performance of a system that uses the return signals generated by the lidar. For example, when the readout system fails to identity sensor signal variations associated with light received from other lidars and generates false return signals, the corresponding confidence signals generated for the return signals (e.g., within the measurement time intervals), may be used to reduce the false return signals.

As described above, the readout circuit 632, the detection control system 640, and the event validation circuit 610 may include a memory and one or more processors configured to execute computer-executable instructions stored in the memory. In some cases, the processors may execute a program to implement a routine or process designed to improve the SNR of the return signals 120, increase the probability of detection, and/or reduce the false alarm rate (FAR) of the lidar detection system 604.

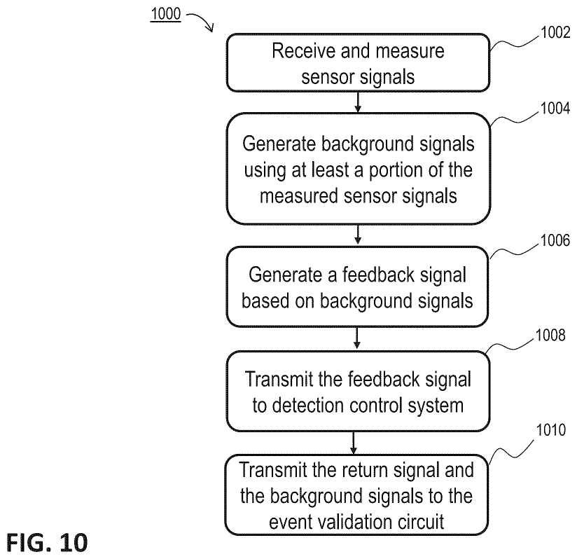

FIG. 10 is a flow diagram illustrating an example of a process or routine 1000 implemented by one or more processors of the readout circuit 632 to generate the return signals 120 and the In some cases, the optical system 310 may include sensor signals from the sensor 320 and measures the received sensor signals. In some cases, the sensor signals may be generated continuously. In some examples, the received sensor signals may include sensor signals from each pixel of the sensor 320. In some examples, the readout circuit 632 may divide the measurement time interval into multiple time windows and measure the sensor signals received during each time window separately.

At block 1004, the readout circuit 632 may generate background signals using at least a portion of measured sensor signals. In some cases, the readout system may generate a return signal using a first portion of a sensor signal and a background signal using a second portion of the sensor signal different than the first portion of the sensor signal where the first and second portions of the first sensor signal are received at two different measurement time windows (e.g., two non-overlapping time windows). In some cases, the readout circuit 632 may generate a background signal for a pixel using sensor signals generated by the pixel during two or more measurement time windows. In some cases, the readout circuit 632 may generate a background signal for a pixel using sensor signals generated by other pixels of the sensor 320.

At block 1006, the readout system 330 may generate a feedback signal using at least a portion of background signals. In some cases, the feedback signal can be a value determined by background signals generated based on sensor signals measured during multiple time intervals.

At block 1008, the readout system 330 may transmit the feedback signal to detection control system 640. In some cases, the feedback signal may be different for different measurement time windows. The detection control system 640 may use the feedback signal to adjust at least one of the read out circuit 632, sensor 320, or optical system 310.

At block 1010, the readout circuit 632 may transmit the return signal and the background signal to the event validation circuit 610. In some examples, the operations at block 1008 and block 1010 may be performed substantially at the same time or sequentially (e.g., with a delay). In some cases, the readout system 330 may not have an event validation circuit 610 or a detection control system 640. In some such cases, the readout circuit 632 may skip block 1008 or block 1010.

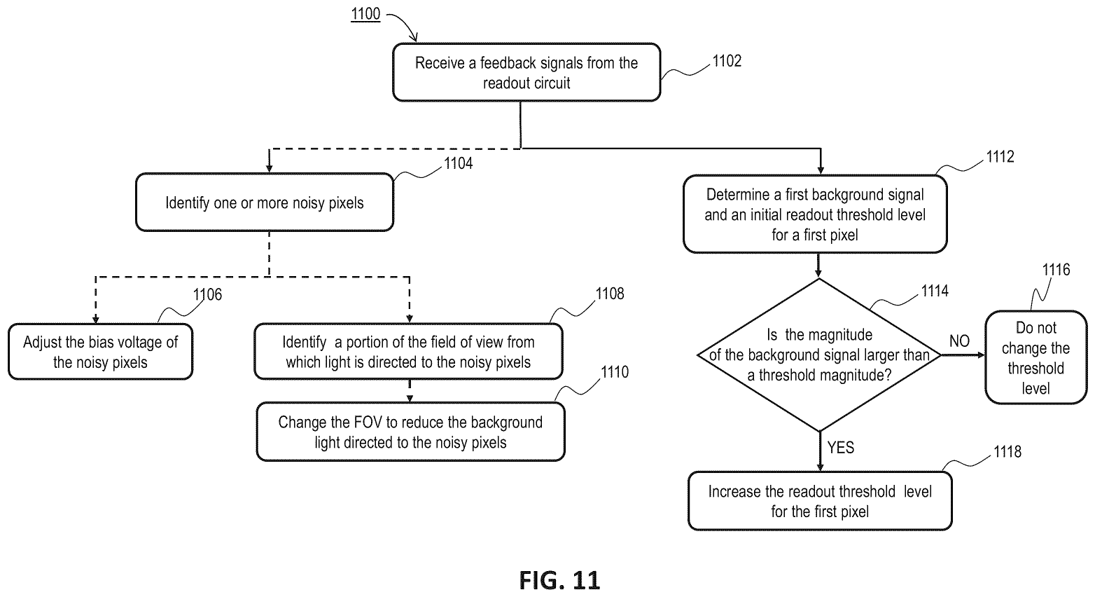

FIG. 11 is a flow diagram illustrating an example of a process or routine 1100 implemented by one or more processors of the detection control system 640 to reduce the FAR of the lidar detection system 604 by controlling the optical system 310, the sensor 320, and/or the readout circuit 632. In some cases, the detection control system 640 may control the optical system 310, the sensor 320, and/or the readout circuit 632 to reduce the SNR of the return signals 120, and/or the magnitude of one or more of the background signals 325.

At block 1102, the detection control system 640 receives a feedback signals from the readout circuit 632. In some cases, the detection control system 640 may use the feedback signals to dynamically control optical system 310 and the sensor 320 and not the readout circuit 632. In these cases, the process moves to block 1104. In some cases, the detection control system 640 may use the feedback signals to dynamically control the readout circuit 632 and not optical system 310 and the sensor 320. In these cases, the process moves to block 1112. In other cases, the detection control system 640 may control dynamically control the readout circuit 632, the optical system 310, and the sensor 320. In some such cases, the process may move to the blocks 1104 and 1112 substantially at the same time or at different times. In some cases, the detection control system 640 may sequentially adjust the optical system 310, the sensor 320, and the readout circuit 632 with different orders and different delays between adjustments.

At block 1104, the detection control system 640 may use the information included in the feedback signal to identify one or more noisy pixels that receive excessive amount of background light. In some examples, the detection control system 640 may identify a noisy pixel by comparing the background signals associated with the noisy pixel and determining that the magnitude of the background signal is larger than a threshold level. In some cases, the detection control system 640 may determine the threshold level based at least in part the background signals associated with other pixels of the sensor 320. In some cases, the threshold level can be a fixed value stored in a memory of the detection control system 640 or the lidar. In some cases, where the detection control system 640 controls both the optical system 310 and the sensor 320, the process may move to the blocks 1106 and 1108 substantially at the same time or at different times. In some cases, the detection control system 640 may control the optical system 310 and not the sensor 320. In these cases, the process moves to block 1108. In some cases, the detection control system 640 may control the sensor 320 and not the optical system 310. In these cases, the process moves to block 1106.

At block 1106, the detection control system 640 may adjust the bias voltage of the all or a portion of the identified noisy pixels to improve the SNR of the return signals that are generated based at least in part the noisy pixels. In some cases, the detection control system 640 may turn off some of the noisy pixels (for example but reducing the bias voltage to zero or close to zero).

At block 1108, the detection control system 640 may identify a portion of the FOV of the optical system 310 from which light is directed to the noisy pixels.

At block 1110, the detection control system 640 may change or adjust the FOV to reduce the amount of light directed to the sensor from directions associated with the identified portion of the original FOV. In some cases, the detection control system 640 may change or adjust the FOV using electro-mechanically controllable optical elements (e.g., micro-mirrors, and/or microlenses).

In some cases, where the optical system 310 includes a reconfigurable spatial optical filter, at block 1108 the detection control system 640 may identify a direction along which a portion of light directed to the noisy pixel is received from the environment and at block 1110, the detection control system 640 may adjust the reconfigurable spatial optical filter to block a portion of light received from the environment along the identified direction to reduce the amount of background light directed from the environment to the sensor 320.

At block 1112, the detection control system 640 may use the feedback signals to determine a first background signal and an initial readout threshold level for a first pixel. In some cases, a readout threshold level can be a threshold value of the sensor signal generated by the first pixel below which the sensor signal may be considered to be associated with background light and not the reflection of an optical probe signal emitted by the lidar.

At the decision block 1114, the detection control system 640 may determine whether the magnitude of the background signal is larger than a threshold noise magnitude. If detection control system 640 determines that the magnitude of the background signal is smaller than a threshold noise magnitude the process moves to block 1116 and the detection control system 640 does not change the first readout threshold level for the first pixel. If detection control system 640 determines that the magnitude of the background signal is larger than a threshold magnitude the process moves to block 1118.

At block 1118, the detection control system 640 may increase the initial readout threshold level for the first pixel to reduce the probability of generation of false return signals based on the sensor signals generated by the first pixel and thereby reducing the FAR for the lidar detection system 604.

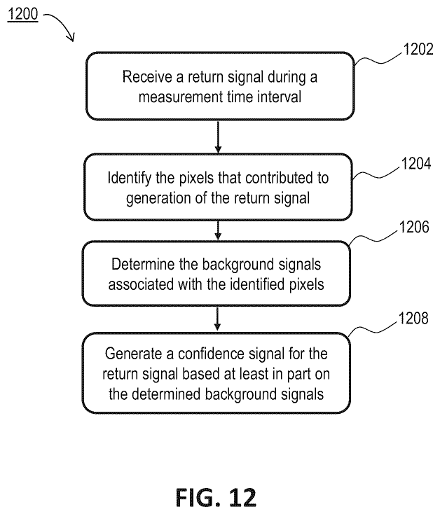

FIG. 12 is a flow diagram illustrating an example of a process or routine 1100 implemented by one or more processors of readout system 330 for generating a confidence signal. In some examples, the process 1100 may be performed by a processor of the event validation circuit 610 of the readout system 330.

At block 1202, the event validation circuit 610 receives a return signal and background signals from the readout circuit 632 during a measurement time interval.

At block 1204, the event validation circuit 610 identifies the pixels that contributed to generation of return signal.

At block 1206, the event validation circuit 610 determines the background signals associated with the identified pixels.

At block 1208, the event validation circuit 610 generates a confidence signal for the return signal where the confidence output could be a value or multiple values that are associated with background signals level, interference condition (e.g. how many return signal detected), internal noise signal level, and or current FAR. In some cases, the levels may be a value stored in a memory of the event validation circuit 610.

The flow diagrams illustrated in FIGS. 10, 11, and 12 are provided for illustrative purposes only. It will be understood that one or more of the steps of the routines illustrated in FIGS. 10, 11, and 12 may be removed or that the ordering of the steps may be changed. Furthermore, for the purposes of illustrating a clear example, one or more particular system components are described in the context of performing various operations during each of the data flow stages. However, other system arrangements and distributions of the processing steps across system components may be used

The flow diagrams illustrated in FIGS. 10, 11, and 12 are provided for illustrative purposes only. It will be understood that one or more of the steps of the routines illustrated in FIGS. 10, 11, and 12 may be removed or that the ordering of the steps may be changed. Furthermore, for the purposes of illustrating a clear example, one or more particular system components are described in the context of performing various operations during each of the data flow stages. However, other system arrangements and distributions of the processing steps across system components may be used.

The above-disclosed lidar windows may be used on lidar devices and systems incorporated into a vehicle as disclosed below. In some aspects and/or embodiments, devices and methods described above may be used in a lidar sensor of an autonomous system included in a vehicle, to improve the autonomous driving capability of the vehicle by reducing the probability of false alarm generation by the lidar sensor (e.g., false alarm associated with indirect light received by the lidar detection system).

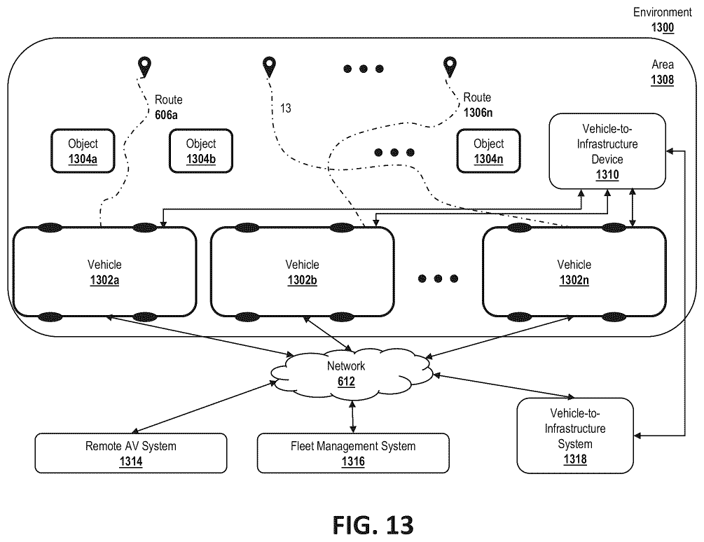

Referring now to FIG. 13, illustrated is example environment 1300 in which vehicles that include autonomous systems, as well as vehicles that do not, are operated. As illustrated, environment 1300 includes vehicles 1302a-1302n, objects 1304a-1304n, routes 1306a-1306n, area 1308, vehicle-to-infrastructure (V2I) device 1310, network 1312, remote autonomous vehicle (AV) system 1314, fleet management system 1316, and V2I system 1318. Vehicles 1302a-1302n, vehicle-to-infrastructure (V2I) device 1310, network 1312, autonomous vehicle (AV) system 1314, fleet management system 1316, and V2I system 1318 interconnect (e.g., establish a connection to communicate and/or the like) via wired connections, wireless connections, or a combination of wired or wireless connections. In some embodiments, objects 1304a-1304n interconnect with at least one of vehicles 1302a-1302n, vehicle-to-infrastructure (V2I) device 1310, network 1312, autonomous vehicle (AV) system 1314, fleet management system 1316, and V2I system 1318 via wired connections, wireless connections, or a combination of wired or wireless connections.

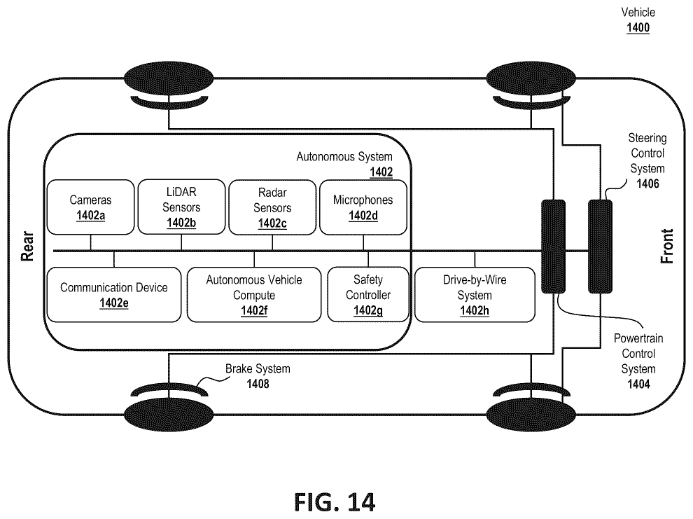

Vehicles 1302a-1302n (referred to individually as vehicle 1302 and collectively as vehicles 1302) include at least one device configured to transport goods and/or people. In some embodiments, vehicles 1302 are configured to be in communication with V2I device 1310, remote AV system 1314, fleet management system 1316, and/or V2I system 1318 via network 1312. In some embodiments, vehicles 1302 include cars, buses, trucks, trains, and/or the like. In some embodiments, vehicles 1302 are the same as, or similar to, vehicles 1400, described herein (see FIG. 14). In some embodiments, a vehicle 1400 of a set of vehicles 1400 is associated with an autonomous fleet manager. In some embodiments, vehicles 1302 travel along respective routes 1306a-1306n (referred to individually as route 1306 and collectively as routes 1306), as described herein. In some embodiments, one or more vehicles 1302 include an autonomous system (e.g., an autonomous system that is the same as or similar to autonomous system 702).

Objects 1304a-1304n (referred to individually as object 1304 and collectively as objects 1304) include, for example, at least one vehicle, at least one pedestrian, at least one cyclist, at least one structure (e.g., a building, a sign, a fire hydrant, etc.), and/or the like. Each object 1304 is stationary (e.g., located at a fixed location for a period of time) or mobile (e.g., having a velocity and associated with at least one trajectory). In some embodiments, objects 1304 are associated with corresponding locations in area 1308.

Routes 1306a-1306n (referred to individually as route 1306 and collectively as routes 1306) are each associated with (e.g., prescribe) a sequence of actions (also known as a trajectory) connecting states along which an AV can navigate. Each route 1306 starts at an initial state (e.g., a state that corresponds to a first spatiotemporal location, velocity, and/or the like) and ends at a final goal state (e.g., a state that corresponds to a second spatiotemporal location that is different from the first spatiotemporal location) or goal region (e.g. a subspace of acceptable states (e.g., terminal states)). In some embodiments, the first state includes a location at which an individual or individuals are to be picked-up by the AV and the second state or region includes a location or locations at which the individual or individuals picked-up by the AV are to be dropped-off. In some embodiments, routes 1306 include a plurality of acceptable state sequences (e.g., a plurality of spatiotemporal location sequences), the plurality of state sequences associated with (e.g., defining) a plurality of trajectories. In an example, routes 1306 include only high-level actions or imprecise state locations, such as a series of connected roads dictating turning directions at roadway intersections. Additionally, or alternatively, routes 1306 may include more precise actions or states such as, for example, specific target lanes or precise locations within the lane areas and targeted speed at those positions. In an example, routes 1306 include a plurality of precise state sequences along the at least one high level action sequence with a limited lookahead horizon to reach intermediate goals, where the combination of successive iterations of limited horizon state sequences cumulatively correspond to a plurality of trajectories that collectively form the high level route to terminate at the final goal state or region.

Area 1308 includes a physical area (e.g., a geographic region) within which vehicles 1302 can navigate. In an example, area 1308 includes at least one state (e.g., a country, a province, an individual state of a plurality of states included in a country, etc.), at least one portion of a state, at least one city, at least one portion of a city, etc. In some embodiments, area 1308 includes at least one named thoroughfare (referred to herein as a “road”) such as a highway, an interstate highway, a parkway, a city street, etc. Additionally, or alternatively, in some examples area 1308 includes at least one unnamed road such as a driveway, a section of a parking lot, a section of a vacant and/or undeveloped lot, a dirt path, etc. In some embodiments, a road includes at least one lane (e.g., a portion of the road that can be traversed by vehicles 1302). In an example, a road includes at least one lane associated with (e.g., identified based on) at least one lane marking.

Vehicle-to-Infrastructure (V2I) device 1310 (sometimes referred to as a Vehicle-to-Infrastructure or Vehicle-to-Everything (V2X) device) includes at least one device configured to be in communication with vehicles 1302 and/or V2I infrastructure system 1318. In some embodiments, V2I device 1310 is configured to be in communication with vehicles 1302, remote AV system 1314, fleet management system 1316, and/or V2I system 1318 via network 1312. In some embodiments, V2I device 1310 includes a radio frequency identification (RFID) device, signage, cameras (e.g., two-dimensional (2D) and/or three-dimensional (3D) cameras), lane markers, streetlights, parking meters, etc. In some embodiments, V2I device 1310 is configured to communicate directly with vehicles 1302. Additionally, or alternatively, in some embodiments V2I device 1310 is configured to communicate with vehicles 1302, remote AV system 1314, and/or fleet management system 1316 via V2I system 1318. In some embodiments, V2I device 1310 is configured to communicate with V2I system 1318 via network 1312.

Network 1312 includes one or more wired and/or wireless networks. In an example, network 1312 includes a cellular network (e.g., a long term evolution (LTE) network, a third generation (3G) network, a fourth generation (4G) network, a fifth generation (5G) network, a code division multiple access (CDMA) network, etc.), a public land mobile network (PLMN), a local area network (LAN), a wide area network (WAN), a metropolitan area network (MAN), a telephone network (e.g., the public switched telephone network (PSTN), a private network, an ad hoc network, an intranet, the Internet, a fiber optic-based network, a cloud computing network, etc., a combination of some or all of these networks, and/or the like.

Remote AV system 1314 includes at least one device configured to be in communication with vehicles 1302, V2I device 1310, network 1312, fleet management system 1316, and/or V2I system 1318 via network 1312. In an example, remote AV system 1314 includes a server, a group of servers, and/or other like devices. In some embodiments, remote AV system 1314 is co-located with the fleet management system 1316. In some embodiments, remote AV system 1314 is involved in the installation of some or all of the components of a vehicle, including an autonomous system, an autonomous vehicle compute, software implemented by an autonomous vehicle compute, and/or the like. In some embodiments, remote AV system 1314 maintains (e.g., updates and/or replaces) such components and/or software during the lifetime of the vehicle.

Fleet management system 1316 includes at least one device configured to be in communication with vehicles 1302, V2I device 1310, remote AV system 1314, and/or V2I infrastructure system 1318. In an example, fleet management system 1316 includes a server, a group of servers, and/or other like devices. In some embodiments, fleet management system 1316 is associated with a ridesharing company (e.g., an organization that controls operation of multiple vehicles (e.g., vehicles that include autonomous systems and/or vehicles that do not include autonomous systems) and/or the like).

In some embodiments, V2I system 1318 includes at least one device configured to be in communication with vehicles 1302, V2I device 1310, remote AV system 1314, and/or fleet management system 1316 via network 1312. In some examples, V2I system 1318 is configured to be in communication with V2I device 1310 via a connection different from network 1312. In some embodiments, V2I system 1318 includes a server, a group of servers, and/or other like devices. In some embodiments, V2I system 1318 is associated with a municipality or a private institution (e.g., a private institution that maintains V2I device 1310 and/or the like).

The number and arrangement of elements illustrated in FIG. 13 are provided as an example. There can be additional elements, fewer elements, different elements, and/or differently arranged elements, than those illustrated in FIG. 13. Additionally, or alternatively, at least one element of environment 1300 can perform one or more functions described as being performed by at least one different element of FIG. 13. Additionally, or alternatively, at least one set of elements of environment 1300 can perform one or more functions described as being performed by at least one different

forego reliance on human intervention in certain situations such as Level 4 ADS-operated vehicles), conditional autonomous vehicles (e.g., vehicles that forego reliance on human intervention in limited situations such as Level 3 ADS-operated vehicles) and/or the like. In one embodiment, autonomous system 1402 includes operational or tactical set of elements of environment 1300. Referring now to FIG. 14, vehicle 1400 (which may be the same as, or similar to vehicles 1302 of FIG. 13) includes or is associated with autonomous system 1402, powertrain control system 1404, steering control system 1406, and brake system 1408. In some embodiments, vehicle 1400 is the same as or similar to vehicle 1302 (see FIG. 13). In some embodiments, autonomous system 1402 is configured to confer vehicle 1400 autonomous driving capability (e.g., implement at least one driving automation or maneuver-based function, feature, device, and/or the like that enable vehicle 1400 to be partially or fully operated without human intervention including, without limitation, fully autonomous vehicles (e.g., vehicles that forego reliance on human intervention such as Level 5 ADS-operated vehicles), highly autonomous vehicles (e.g., vehicles that functionality required to operate vehicle 1400 in on-road traffic and perform part or all of Dynamic Driving Task (DDT) on a sustained basis. In another embodiment, autonomous system 1402 includes an Advanced Driver Assistance System (ADAS) that includes driver support features. Autonomous system 1402 supports various levels of driving automation, ranging from no driving automation (e.g., Level 0) to full driving automation (e.g., Level 5). For a detailed description of fully autonomous vehicles and highly autonomous vehicles, reference may be made to SAE International's standard J3016: Taxonomy and Definitions for Terms Related to On-Road Motor Vehicle Automated Driving Systems, which is incorporated by reference in its entirety. In some embodiments, vehicle 1400 is associated with an autonomous fleet manager and/or a ridesharing company.

Autonomous system 1402 includes a sensor suite that includes one or more devices such as cameras 1402a, LiDAR sensors 1402b, radar sensors 1402c, and microphones 1402d. In some embodiments, autonomous system 1402 can include more or fewer devices and/or different devices (e.g., ultrasonic sensors, inertial sensors, GPS receivers (discussed below), odometry sensors that generate data associated with an indication of a distance that vehicle 1400 has traveled, and/or the like). In some embodiments, autonomous system 1402 uses the one or more devices included in autonomous system 1402 to generate data associated with environment 1300, described herein. The data generated by the one or more devices of autonomous system 1402 can be used by one or more systems described herein to observe the environment (e.g., environment 1300) in which vehicle 1400 is located. In some embodiments, autonomous system 1402 includes communication device 1402e, autonomous vehicle compute 1402f, drive-by-wire (DBW) system 1402h, and safety controller 1402g.

In some cases, at least the LiDAR sensors 1402b, may have a lidar window comprising one or more features described above with respect to reducing the intensity of light indirectly received by the corresponding lidar detection system via optical guiding within the thickness of the lidar window.

Cameras 1402a include at least one device configured to be in communication with communication device 1402e, autonomous vehicle compute 1402f, and/or safety controller 1402g via a bus (e.g., a bus that is the same as or similar to bus 802 of FIG. 8). Cameras 1402a include at least one camera (e.g., a digital camera using a light sensor such as a Charge Coupled Device (CCD), a thermal camera, an infrared (IR) camera, an event camera, and/or the like) to capture images including physical objects (e.g., cars, buses, curbs, people, and/or the like). In some embodiments, camera 1402a generates camera data as output. In some examples, camera 1402a generates camera data that includes image data associated with an image. In this example, the image data may specify at least one parameter (e.g., image characteristics such as exposure, brightness, etc., an image timestamp, and/or the like) corresponding to the image. In such an example, the image may be in a format (e.g., RAW, JPEG, PNG, and/or the like). In some embodiments, camera 1402a includes a plurality of independent cameras configured on (e.g., positioned on) a vehicle to capture images for the purpose of stereopsis (stereo vision). In some examples, camera 1402a includes a plurality of cameras that generate image data and transmit the image data to autonomous vehicle compute 1402f and/or a fleet management system (e.g., a fleet management system that is the same as or similar to fleet management system 1316 of FIG. 13). In such an example, autonomous vehicle compute 1402f determines depth to one or more objects in a field of view of at least two cameras of the plurality of cameras based on the image data from the at least two cameras. In some embodiments, cameras 1402a is configured to capture images of objects within a distance from cameras 1402a (e.g., up to 1300 meters, up to a kilometer, and/or the like). Accordingly, cameras 1402a include features such as sensors and lenses that are optimized for perceiving objects that are at one or more distances from cameras 1402a.

In an embodiment, camera 1402a includes at least one camera configured to capture one or more images associated with one or more traffic lights, street signs and/or other physical objects that provide visual navigation information. In some embodiments, camera 1402a generates traffic light data associated with one or more images. In some examples, camera 1402a generates TLD (Traffic Light Detection) data associated with one or more images that include a format (e.g., RAW, JPEG, PNG, and/or the like). In some embodiments, camera 1402a that generates TLD data differs from other systems described herein incorporating cameras in that camera 1402a can include one or more cameras with a wide field of view (e.g., a wide-angle lens, a fish-eye lens, a lens having a viewing angle of approximately 120 degrees or more, and/or the like) to generate images about as many physical objects as possible.

Light Detection and Ranging (LiDAR) sensors 1402b include at least one device configured to be in communication with communication device 1402e, autonomous vehicle compute 1402f, and/or safety controller 1402g via a bus (e.g., a bus that is the same as or similar to bus 802 of FIG. 8). LiDAR sensors 1402b include a system configured to transmit light from a light emitter (e.g., a laser transmitter). Light emitted by LiDAR sensors 1402b include light (e.g., infrared light and/or the like) that is outside of the visible spectrum. In some embodiments, during operation, light emitted by LiDAR sensors 1402b encounters a physical object (e.g., a vehicle) and is reflected back to LiDAR sensors 1402b. In some embodiments, the light emitted by LiDAR sensors 1402b does not penetrate the physical objects that the light encounters. LiDAR sensors 1402b also include at least one light detector which detects the light that was emitted from the light emitter after the light encounters a physical object. In some embodiments, at least one data processing system associated with LiDAR sensors 1402b generates an image (e.g., a point cloud, a combined point cloud, and/or the like) representing the objects included in a field of view of LiDAR sensors 1402b. In some examples, the at least one data processing system associated with LiDAR sensor 1402b generates an image that represents the boundaries of a physical object, the surfaces (e.g., the topology of the surfaces) of the physical object, and/or the like. In such an example, the image is used to determine the boundaries of physical objects in the field of view of LiDAR sensors 1402b.

Radio Detection and Ranging (radar) sensors 1402c include at least one device configured to be in communication with communication device 1402e, autonomous vehicle compute 1402f, and/or safety controller 1402g via a bus (e.g., a bus that is the same as or similar to bus 802 of FIG. 8). Radar sensors 1402c include a system configured to transmit radio waves (either pulsed or continuously). The radio waves transmitted by radar sensors 1402c include radio waves that are within a predetermined spectrum In some embodiments, during operation, radio waves transmitted by radar sensors 1402c encounter a physical object and are reflected back to radar sensors 1402c. In some embodiments, the radio waves transmitted by radar sensors 1402c are not reflected by some objects. In some embodiments, at least one data processing system associated with radar sensors 1402c generates signals representing the objects included in a field of view of radar sensors 1402c. For example, the at least one data processing system associated with radar sensor 1402c generates an image that represents the boundaries of a physical object, the surfaces (e.g., the topology of the surfaces) of the physical object, and/or the like. In some examples, the image is used to determine the boundaries of physical objects in the field of view of radar sensors 1402c.

Microphones 1402d includes at least one device configured to be in communication with communication device 1402e, autonomous vehicle compute 1402f, and/or safety controller 1402g via a bus (e.g., a bus that is the same as or similar to bus 802 of FIG. 8). Microphones 1402d include one or more microphones (e.g., array microphones, external microphones, and/or the like) that capture audio signals and generate data associated with (e.g., representing) the audio signals. In some examples, microphones 1402d include transducer devices and/or like devices. In some embodiments, one or more systems described herein can receive the data generated by microphones 1402d and determine a position of an object relative to vehicle 1400 (e.g., a distance and/or the like) based on the audio signals associated with the data.

Communication device 1402e includes at least one device configured to be in communication with cameras 1402a, LiDAR sensors 1402b, radar sensors 1402c, microphones 1402d, autonomous vehicle compute 1402f, safety controller 1402g, and/or DBW (Drive-By-Wire) system 1402h. For example, communication device 1402e may include a device that is the same as or similar to communication interface 814 of FIG. 8. In some embodiments, communication device 1402e includes a vehicle-to-vehicle (V2V) communication device (e.g., a device that enables wireless communication of data between vehicles).

Autonomous vehicle compute 1402f include at least one device configured to be in communication with cameras 1402a, LiDAR sensors 1402b, radar sensors 1402c, microphones 1402d, communication device 1402e, safety controller 1402g, and/or DBW system 1402h. In some examples, autonomous vehicle compute 1402f includes a device such as a client device, a mobile device (e.g., a cellular telephone, a tablet, and/or the like), a server (e.g., a computing device including one or more central processing units, graphical processing units, and/or the like), and/or the like. In some embodiments, autonomous vehicle compute 1402f is the same as or similar to autonomous vehicle compute 400, described herein. Additionally, or alternatively, in some embodiments autonomous vehicle compute 1402f is configured to be in communication with an autonomous vehicle system (e.g., an autonomous vehicle system that is the same as or similar to remote AV system 1314 of FIG. 13), a fleet management system (e.g., a fleet management system that is the same as or similar to fleet management system 1316 of FIG. 13), a V2I device (e.g., a V2I device that is the same as or similar to V2I device 1310 of FIG. 13), and/or a V2I system (e.g., a V2I system that is the same as or similar to V2I system 1318 of FIG. 13).

Safety controller 1402g includes at least one device configured to be in communication with cameras 1402a, LiDAR sensors 1402b, radar sensors 1402c, microphones 1402d, communication device 1402e, autonomous vehicle computer 1402f, and/or DBW system 1402h. In some examples, safety controller 1402g includes one or more controllers (electrical controllers, electromechanical controllers, and/or the like) that are configured to generate and/or transmit control signals to operate one or more devices of vehicle 1400 (e.g., powertrain control system 1404, steering control system 1406, brake system 1408, and/or the like). In some embodiments, safety controller 1402g is configured to generate control signals that take precedence over (e.g., overrides) control signals generated and/or transmitted by autonomous vehicle compute 1402f.

DBW system 1402h includes at least one device configured to be in communication with communication device 1402e and/or autonomous vehicle compute 1402f. In some examples, DBW system 1402h includes one or more controllers (e.g., electrical controllers, electromechanical controllers, and/or the like) that are configured to generate and/or transmit control signals to operate one or more devices of vehicle 1400 (e.g., powertrain control system 1404, steering control system 1406, brake system 1408, and/or the like). Additionally, or alternatively, the one or more controllers of DBW system 1402h are configured to generate and/or transmit control signals to operate at least one different device (e.g., a turn signal, headlights, door locks, windshield wipers, and/or the like) of vehicle 1400.

Powertrain control system 1404 includes at least one device configured to be in communication with DBW system 1402h. In some examples, powertrain control system 1404 includes at least one controller, actuator, and/or the like. In some embodiments, powertrain control system 1404 receives control signals from DBW system 1402h and powertrain control system 1404 causes vehicle 1400 to make longitudinal vehicle motion, such as start moving forward, stop moving forward, start moving backward, stop moving backward, accelerate in a direction, decelerate in a direction or to make lateral vehicle motion such as performing a left turn, performing a right turn, and/or the like. In an example, powertrain control system 1404 causes the energy (e.g., fuel, electricity, and/or the like) provided to a motor of the vehicle to increase, remain the same, or decrease, thereby causing at least one wheel of vehicle 1400 to rotate or not rotate.

Steering control system 1406 includes at least one device configured to rotate one or more wheels of vehicle 1400. In some examples, steering control system 1406 includes at least one controller, actuator, and/or the like. In some embodiments, steering control system 1406 causes the front two wheels and/or the rear two wheels of vehicle 1400 to rotate to the left or right to cause vehicle 1400 to turn to the left or right. In other words, steering control system 1406 causes activities necessary for the regulation of the y-axis component of vehicle motion.

Brake system 1408 includes at least one device configured to actuate one or more brakes to cause vehicle 1400 to reduce speed and/or remain stationary. In some examples, brake system 1408 includes at least one controller and/or actuator that is configured to cause one or more calipers associated with one or more wheels of vehicle 1400 to close on a corresponding rotor of vehicle 1400. Additionally, or alternatively, in some examples brake system 1408 includes an automatic emergency braking (AEB) system, a regenerative braking system, and/or the like.

In some embodiments, vehicle 1400 includes at least one platform sensor (not explicitly illustrated) that measures or infers properties of a state or a condition of vehicle 1400. In some examples, vehicle 1400 includes platform sensors such as a global positioning system (GPS) receiver, an inertial measurement unit (IMU), a wheel speed sensor, a wheel brake pressure sensor, a wheel torque sensor, an engine torque sensor, a steering angle sensor, and/or the like. Although brake system 1408 is illustrated to be located in the near side of vehicle 1400 in FIG. 14, brake system 1408 may be located anywhere in vehicle 1400.

In some embodiments, the one or more lidar sensors of the lidar sensors 1402b of the autonomous system 1402 may comprise the lidar detection system 604, and/or the lidar detection system 800.

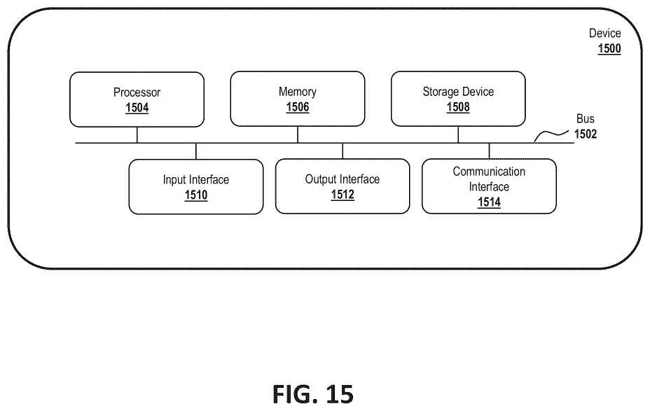

Referring now to FIG. 15, illustrated is a schematic diagram of a device 1500. As illustrated, device 1500 includes processor 1504, memory 1506, storage component 1508, input interface 1510, output interface 1512, communication interface 1514, and bus 1502. In some embodiments, device 1500 corresponds to at least one device of vehicles 602a-602n, at least one device of vehicle 1400, and/or one or more devices of network 612. In some embodiments, one or more devices of vehicles 602a-602n, and/or one or more devices of network 612 include at least one device 1500 and/or at least one component of device 1500. As shown in FIG. 15, device 1500 includes bus 1502, processor 1504, memory 1506, storage component 1508, input interface 1510, output interface 1512, and communication interface 1514.

Bus 1502 includes a component that permits communication among the components of device 1500. In some cases, the processor 1504 includes a processor (e.g., a central processing unit (CPU), a graphics processing unit (GPU), an accelerated processing unit (APU), and/or the like), a microphone, a digital signal processor (DSP), and/or any processing component (e.g., a field-programmable gate array (FPGA), an application specific integrated circuit (ASIC), and/or the like) that can be programmed to perform at least one function. Memory 1506 includes random access memory (RAM), read-only memory (ROM), and/or another type of dynamic and/or static storage device (e.g., flash memory, magnetic memory, optical memory, and/or the like) that stores data and/or instructions for use by processor 1504.

Storage component 1508 stores data and/or software related to the operation and use of device 1500. In some examples, storage component 1508 includes a hard disk (e.g., a magnetic disk, an optical disk, a magneto-optic disk, a solid state disk, and/or the like), a compact disc (CD), a digital versatile disc (DVD), a floppy disk, a cartridge, a magnetic tape, a CD-ROM, RAM, PROM, EPROM, FLASH-EPROM, NV-RAM, and/or another type of computer readable medium, along with a corresponding drive.

Input interface 1510 includes a component that permits device 1500 to receive information, such as via user input (e.g., a touchscreen display, a keyboard, a keypad, a mouse, a button, a switch, a microphone, a camera, and/or the like). Additionally or alternatively, in some embodiments input interface 1510 includes a sensor that senses information (e.g., a global positioning system (GPS) receiver, an accelerometer, a gyroscope, an actuator, and/or the like). Output interface 1512 includes a component that provides output information from device 1500 (e.g., a display, a speaker, one or more light-emitting diodes (LEDs), and/or the like).

In some embodiments, communication interface 1514 includes a transceiver-like component (e.g., a transceiver, a separate receiver and transmitter, and/or the like) that permits device 1500 to communicate with other devices via a wired connection, a wireless connection, or a combination of wired and wireless connections. In some examples, communication interface 1514 permits device 1500 to receive information from another device and/or provide information to another device. In some examples, communication interface 1514 includes an Ethernet interface, an optical interface, a coaxial interface, an infrared interface, a radio frequency (RF) interface, a universal serial bus (USB) interface, a Wi-Fi® interface, a cellular network interface, and/or the like.

In some embodiments, device 1500 performs one or more processes described herein. Device 1500 performs these processes based on processor 1504 executing software instructions stored by a computer-readable medium, such as memory 305 and/or storage component 1508. A computer-readable medium (e.g., a non-transitory computer readable medium) is defined herein as a non-transitory memory device. A non-transitory memory device includes memory space located inside a single physical storage device or memory space spread across multiple physical storage devices.

In some embodiments, software instructions are read into memory 1506 and/or storage component 1508 from another computer-readable medium or from another device via communication interface 1514. When executed, software instructions stored in memory 1506 and/or storage component 1508 cause processor 1504 to perform one or more processes described herein. Additionally or alternatively, hardwired circuitry is used in place of or in combination with software instructions to perform one or more processes described herein. Thus, embodiments described herein are not limited to any specific combination of hardware circuitry and software unless explicitly stated otherwise.

Memory 1506 and/or storage component 1508 includes data storage or at least one data structure (e.g., a database and/or the like). Device 1500 is capable of receiving information from, storing information in, communicating information to, or searching information stored in the data storage or the at least one data structure in memory 1506 or storage component 1508. In some examples, the information includes network data, input data, output data, or any combination thereof.

In some embodiments, device 1500 is configured to execute software instructions that are either stored in memory 1506 and/or in the memory of another device (e.g., another device that is the same as or similar to device 1500). As used herein, the term “module” refers to at least one instruction stored in memory 1506 and/or in the memory of another device that, when executed by processor 1504 and/or by a processor of another device (e.g., another device that is the same as or similar to device 1500) cause device 1500 (e.g., at least one component of device 1500) to perform one or more processes described herein. In some embodiments, a module is implemented in software, firmware, hardware, and/or the like.

The number and arrangement of components illustrated in FIG. 15 are provided as an example. In some embodiments, device 1500 can include additional components, fewer components, different components, or differently arranged components than those illustrated in FIG. 15. Additionally or alternatively, a set of components (e.g., one or more components) of device 1500 can perform one or more functions described as being performed by another component or another set of components of device 1500.

In some implementations, one or more component systems of the lidar detection system 604 may comprise one or more components of the device 1500. For example, the readout system 330, event validation circuit 610, and/or the detection control system 640, may comprise the processor 1504 and/or memory 1506.

In some implementations, one or more component systems of the lidar system 100 may comprise one or more components of the device 1500. For example, the lidar detection system 104, and/or the lidar signal processing system 106, may comprise the processor 1504 and/or memory 1506.

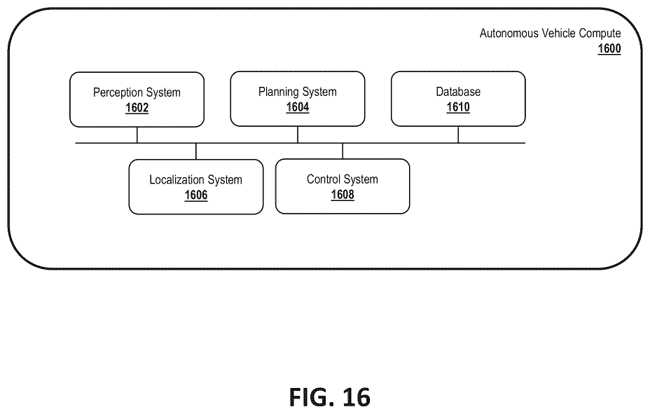

Referring now to FIG. 16, illustrated is an example block diagram of an autonomous vehicle compute 1600 (sometimes referred to as an “AV stack”). As illustrated, autonomous vehicle compute 1600 includes perception system 1602 (sometimes referred to as a perception module), planning system 1604 (sometimes referred to as a planning module), localization system 1606 (sometimes referred to as a localization module), control system 1608 (sometimes referred to as a control module), and database 1610. In some embodiments, perception system 1602, planning system 1604, localization system 1606, control system 1608, and database 1610 are included and/or implemented in an autonomous navigation system of a vehicle (e.g., autonomous vehicle compute 1402f of vehicle 1400). Additionally, or alternatively, in some embodiments perception system 1602, planning system 1604, localization system 1606, control system 1608, and database 1610 are included in one or more standalone systems (e.g., one or more systems that are the same as or similar to autonomous vehicle compute 1600 and/or the like). In some examples, perception system 1602, planning system 1604, localization system 1606, control system 1608, and database 1610 are included in one or more standalone systems that are located in a vehicle and/or at least one remote system as described herein. In some embodiments, any and/or all of the systems included in autonomous vehicle compute 1600 are implemented in software (e.g., in software instructions stored in memory), computer hardware (e.g., by microprocessors, microcontrollers, application-specific integrated circuits (ASICs), Field Programmable Gate Arrays (FPGAs), and/or the like), or combinations of computer software and computer hardware. It will also be understood that, in some embodiments, autonomous vehicle compute 1600 is configured to be in communication with a remote system (e.g., an autonomous vehicle system that is the same as or similar to remote AV system 614, a fleet management system 616 that is the same as or similar to fleet management system 616, a V2I system that is the same as or similar to V2I system 618, and/or the like).

In some embodiments, perception system 1602 receives data associated with at least one physical object (e.g., data that is used by perception system 1602 to detect the at least one physical object) in an environment and classifies the at least one physical object. In some examples, perception system 1602 receives image data captured by at least one camera (e.g., cameras 1402a), the image associated with (e.g., representing) one or more physical objects within a field of view of the at least one camera. In such an example, perception system 1602 classifies at least one physical object based on one or more groupings of physical objects (e.g., bicycles, vehicles, traffic signs, pedestrians, and/or the like). In some embodiments, perception system 1602 transmits data associated with the classification of the physical objects to planning system 1604 based on perception system 1602 classifying the physical objects.

In some embodiments, planning system 1604 receives data associated with a destination and generates data associated with at least one route (e.g., routes 606) along which a vehicle (e.g., vehicles 602) can travel along toward a destination. In some embodiments, planning system 1604 periodically or continuously receives data from perception system 1602 (e.g., data associated with the classification of physical objects, described above) and planning system 1604 updates the at least one trajectory or generates at least one different trajectory based on the data generated by perception system 1602. In other words, planning system 1604 may perform tactical function-related tasks that are required to operate vehicle 602 in on-road traffic. Tactical efforts involve maneuvering the vehicle in traffic during a trip, including but not limited to deciding whether and when to overtake another vehicle, change lanes, or selecting an appropriate speed, acceleration, deacceleration, etc. In some embodiments, planning system 1604 receives data associated with an updated position of a vehicle (e.g., vehicles 602) from localization system 1606 and planning system 1604 updates the at least one trajectory or generates at least one different trajectory based on the data generated by localization system 1606.

In some embodiments, localization system 1606 receives data associated with (e.g., representing) a location of a vehicle (e.g., vehicles 602) in an area. In some examples, localization system 1606 receives LiDAR data associated with at least one point cloud generated by at least one LiDAR sensor (e.g., LiDAR sensors 1402b). In certain examples, localization system 1606 receives data associated with at least one point cloud from multiple LiDAR sensors and localization system 1606 generates a combined point cloud based on each of the point clouds. In these examples, localization system 1606 compares the at least one point cloud or the combined point cloud to two-dimensional (2D) and/or a three-dimensional (3D) map of the area stored in database 1610. Localization system 1606 then determines the position of the vehicle in the area based on localization system 1606 comparing the at least one point cloud or the combined point cloud to the map. In some embodiments, the map includes a combined point cloud of the area generated prior to navigation of the vehicle. In some embodiments, maps include, without limitation, high-precision maps of the roadway geometric properties, maps describing road network connectivity properties, maps describing roadway physical properties (such as traffic speed, traffic volume, the number of vehicular and cyclist traffic lanes, lane width, lane traffic directions, or lane marker types and locations, or combinations thereof), and maps describing the spatial locations of road features such as crosswalks, traffic signs or other travel signals of various types. In some embodiments, the map is generated in real-time based on the data received by the perception system.

In another example, localization system 1606 receives Global Navigation Satellite System (GNSS) data generated by a global positioning system (GPS) receiver. In some examples, localization system 1606 receives GNSS data associated with the location of the vehicle in the area and localization system 1606 determines a latitude and longitude of the vehicle in the area. In such an example, localization system 1606 determines the position of the vehicle in the area based on the latitude and longitude of the vehicle. In some embodiments, localization system 1606 generates data associated with the position of the vehicle. In some examples, localization system 1606 generates data associated with the position of the vehicle based on localization system 1606 determining the position of the vehicle. In such an example, the data associated with the position of the vehicle includes data associated with one or more semantic properties corresponding to the position of the vehicle.

In some embodiments, control system 1608 receives data associated with at least one trajectory from planning system 1604 and control system 1608 controls operation of the vehicle. In some examples, control system 1608 receives data associated with at least one trajectory from planning system 1604 and control system 1608 controls operation of the vehicle by generating and transmitting control signals to cause a powertrain control system (e.g., DBW system 1402h, powertrain control system 1404, and/or the like), a steering control system (e.g., steering control system 1406), and/or a brake system (e.g., brake system 1408) to operate. For example, control system 1608 is configured to perform operational functions such as a lateral vehicle motion control or a longitudinal vehicle motion control. The lateral vehicle motion control causes activities necessary for the regulation of the y-axis component of vehicle motion. The longitudinal vehicle motion control causes activities necessary for the regulation of the x-axis component of vehicle motion. In an example, where a trajectory includes a left turn, control system 1608 transmits a control signal to cause steering control system 1406 to adjust a steering angle of vehicle 1400, thereby causing vehicle 1400 to turn left. Additionally, or alternatively, control system 1608 generates and transmits control signals to cause other devices (e.g., headlights, turn signal, door locks, windshield wipers, and/or the like) of vehicle 1400 to change states.

In some embodiments, perception system 1602, planning system 1604, localization system 1606, and/or control system 1608 implement at least one machine learning model (e.g., at least one multilayer perceptron (MLP), at least one convolutional neural network (CNN), at least one recurrent neural network (RNN), at least one autoencoder, at least one transformer, and/or the like). In some examples, perception system 1602, planning system 1604, localization system 1606, and/or control system 1608 implement at least one machine learning model alone or in combination with one or more of the above-noted systems. In some examples, perception system 1602, planning system 1604, localization system 1606, and/or control system 1608 implement at least one machine learning model as part of a pipeline (e.g., a pipeline for identifying one or more objects located in an environment and/or the like). Database 1610 stores data that is transmitted to, received from, and/or updated by perception system 1602, planning system 1604, localization system 1606 and/or control system 1608. In some examples, database 1610 includes a storage component (e.g., a storage component that is the same as or similar to storage component 808 of FIG. 8) that stores data and/or software related to the operation and uses at least one system of autonomous vehicle compute 1600. In some embodiments, database 1610 stores data associated with 2D and/or 3D maps of at least one area. In some examples, database 1610 stores data associated with 2D and/or 3D maps of a portion of a city, multiple portions of multiple cities, multiple cities, a county, a state, a State (e.g., a country), and/or the like). In such an example, a vehicle (e.g., a vehicle that is the same as or similar to vehicles 602 and/or vehicle 1400) can drive along one or more drivable regions (e.g., single-lane roads, multi-lane roads, highways, back roads, off road trails, and/or the like) and cause at least one LiDAR sensor (e.g., a LiDAR sensor that is the same as or similar to LiDAR sensors 1402b) to generate data associated with an image representing the objects included in a field of view of the at least one LiDAR sensor.

In some embodiments, database 1610 can be implemented across a plurality of devices. In some examples, database 1610 is included in a vehicle (e.g., a vehicle that is the same as or similar to vehicles 602 and/or vehicle 1400), an autonomous vehicle system (e.g., an autonomous vehicle system that is the same as or similar to remote AV system 614, a fleet management system (e.g., a fleet management system that is the same as or similar to fleet management system 616 of FIG. 6, a V2I system (e.g., a V2I system that is the same as or similar to V2I system 618 of FIG. 6) and/or the like.

### Example Embodiments

Some additional nonlimiting examples of embodiments discussed above are provided below. These should not be read as limiting the breadth of the disclosure in any way.

### Group 1

Example 1. A system, comprising:
an optical system configured to receive light from an environment through a field of view of the system;
a sensor configured to receive the light from the optical system and generate a plurality of sensor signals in response to the light, the sensor comprising a plurality of pixels, wherein a pixel of the plurality of pixels generates a sensor signal of the plurality of sensor signals;
a readout system configured to:
   generate a plurality of return signals based on the plurality of sensor signals received from the sensor, wherein a return signal of the plurality of return signals is generated using the sensor signal, wherein the return signal is configured to indicate a reflection of an optical probe signal, wherein the optical probe signal is generated by a first light source of the system,
   generate a plurality of background signals based at least in part on the plurality of sensor signals received from the sensor, wherein a background signal of the plurality of background signals is generated based at least in part on the sensor signal, wherein the background signal is configured to indicate a magnitude of light generated by a second light source different from the first light source, and
   generate a feedback signal based at least in part on the background signal,
a detection control system configured to use the feedback signal to dynamically adjust at least one of the optical system, sensor, or readout system.
Example 2. The system of Example 1, wherein the detection control system dynamically adjusts at least one of the optical system, sensor, or readout system to:
reduce a false alarm rate of the system, wherein the false alarm rate indicates a rate of generation of return signals that are not associated with a reflection of an optical probe signal; or
improve a detection of probability of the system.
Example 3. The system of any of Examples 1 and 2, wherein the detection control system dynamically adjusts at least one of the optical system, sensor, or readout system to increase a signal-to-noise ratio of at least one of a subsequent return signal generated after the return signal or a subsequent sensor signal generated after the sensor signal.
Example 4. The system of any of Examples 1-3, wherein the sensor comprises at least one reference pixel or reference subpixel and the background signal is generated at least partly by the at least one reference pixel or reference subpixel.
Example 5. The system of Example 4 wherein the at least one reference pixel or reference subpixel comprises an optical filter having a passband broader than an operating wavelength range of the system.
Example 6. The system of any of Examples 4 and 5 wherein the readout system generates the background signal based at least in part on a reference sensor signal.
Example 7. The system of Example 6, wherein the reference sensor signal is generated at least partly by a reference subpixel of the pixel, and wherein the reference sensor signal is at least partially associated with a portion of the light received from the optical system having wavelengths different from a wavelength of the optical probe signal.
Example 8. The system of Example 7, wherein the reference subpixel comprises an optical filter having a passband broader than an operating wavelength range of the system.
Example 9. The system of any of Examples 1-8, wherein the readout system generates the background signal based at least in part on sensor signals different from the sensor signal.
Example 10. The system of any of Examples 1-9, wherein the pixel comprises a plurality of microcells.
Example 11. The system of Example 10, wherein the sensor signal is generated by a portion of the plurality of microcells.
Example 12. The system of any of Examples 1-11, wherein at least a portion of the plurality of background signals are generated at least partially based on a portion of the light received from the optical system having wavelengths different from a wavelength of the optical probe signal.
Example 13. The system of any of Examples 1-12, wherein the second light source comprises another light emitting system, or sun light.
Example 14. The system of any of Examples 1-13, wherein the readout system generates the background signal and the return signal using a portion of the sensor signal.
Example 15. The system of any of Examples 1-14, wherein the readout system generates the return signal using a first portion of the sensor signal and the background signal using a second portion of the sensor signal different than the first portion.
Example 16. The system of Example 15, wherein the first and second portions of the sensor signal are received at two different measurement time windows.
Example 17. The system of Example 16, wherein the two different measurement time windows are non-overlapping.
Example 18. The system of any of Examples 1-17, wherein the readout system is further configured to generate the background signal using sensor signals generated by the pixel during one or more measurement time windows.
Example 19. The system of any of Example 1-18, wherein the feedback signal indicates an amplitude distribution of background signals over a plurality of pixels of the sensor.
Example 20. The system of any of Examples 1-19, wherein the detection control system is configured to dynamically control the optical system to increase a signal-to-noise ratio of at least one of a subsequent return signal generated after the return signal or a subsequent sensor signal generated after the sensor signal.
Example 21. The system of any of Examples 1-20, wherein the detection control system is configured to control the optical system by:
identifying one or more noisy pixels of the sensor that are associated with background signals larger than a threshold value to identify a portion of the field of view from which light is directed to the one or more noisy pixels; and
changing the field of view based on the identified portion of the field of view to reduce a level of background light received by at least a portion of the one or more noisy pixels.
Example 22. The system of any of Examples 1-21, wherein the optical system comprises at least one reconfigurable spatial optical filter and wherein the detection control system is configured to control the optical system by:
identifying a noisy pixel of the sensor that is associated with a background signal having magnitudes larger than a threshold value;
identifying a direction along which at least a portion of light directed to the noisy pixel is received from the environment;
adjusting the reconfigurable spatial optical filter to reduce an amount of light received from the environment along the identified direction.
Example 23. The system of any of Examples 1-22, wherein the detection control system is configured to control the readout system by adjusting an event validation threshold level.
Example 24. The system of any of Examples 1-23, wherein the detection control system is configured to reduce a signal-to-noise ratio of at least a portion of the plurality of sensor signals and/or the plurality of return signals by:
identifying pixels that generate background signals having magnitudes larger than a threshold level using the feedback signal; and
adjusting the readout system to reduce contribution of sensor signals generated by the identified pixels, in generation of the at least a portion of the plurality of sensor signals and/or the plurality of return signals.
Example 25. The system of Example 24, wherein the detection control system is configured to turning off the identified pixels or changing a bias voltage of the identified pixels.
Example 26. The system of any of Examples 1-25, wherein the readout system is further configured to generate at least one confidence signal that indicates a probability that the return signal corresponds to the reflection of the optical probe signal from an object in the environment.
Example 28. A method implemented by at least one processor a range finding system, the method comprising:
obtaining, by the at least one processor, a plurality of sensor signals from a sensor, wherein the plurality of sensor signals are response to light received at an optical system from an environment, wherein the sensor comprises a plurality of pixels, and wherein a pixel of the plurality of pixels generates a sensor signal of the plurality of sensor signals;
generating, by the at least one processor, a plurality of return signals based on the plurality of sensor signals using a readout system, wherein a return signal of the plurality of return signals is generated using the sensor signal, wherein the return signal is configured to indicate a reflection of an optical probe signal, wherein the optical probe signal is generated by a first light source of the range finding system,
generating, by the at least one processor, a plurality of background signals based at least in part on the plurality of sensor signals using a readout system, wherein a background signal of the plurality of background signals is generated based at least in part on the sensor signal, and wherein the background signal is configured to indicate a magnitude of light generated by a second light source different from the first light source, and
generating, by the at least one processor, a feedback signal based at least in part on the background signal using a readout system,
dynamically adjusting, by the at least one processor, at least one of the optical system, sensor, or the readout system, based on the feedback signal, using a detection control system.
Example 29. The method of Example 28, wherein dynamically adjusting, by the at least one processor, at least one of the optical system, the sensor, or readout system:
reduces a false alarm rate of the range finding system, wherein the false alarm rate indicates a rate of generation of return signals that are not associated with a reflection of an optical probe signal; or
improves a detection of probability of the range finding system.
Example 30. The method of any of Examples 28 or 29, wherein dynamically adjusting, by the at least one processor, at least one of the optical system, the sensor, or readout system, increases a signal-to-noise ratio of at least one of a subsequent return signal generated after the return signal or a subsequent sensor signal generated after the sensor signal.
Example 31. The method of any of Examples 28-30, wherein the sensor comprises at least one reference pixel or reference subpixel and the background signal is generated at least partly by the at least one reference pixel or reference subpixel.
Example 32. The method of Example 31 wherein the at least one reference pixel or reference subpixel comprises an optical filter having a passband broader than an operating wavelength range of the range finding system.
Example 33. The method of any of Examples 31 and 32 wherein the background signal is generated based at least in part on a reference sensor signal.
Example 34. The method of Example 33, wherein the reference sensor signal is generated at least partly by a reference subpixel of the pixel, and wherein the reference sensor signal is at least partially associated with a portion of the light received from the optical system having wavelengths different from a wavelength of the optical probe signal.
Example 35. The method of Example 34, wherein the reference subpixel comprises an optical filter having a passband broader than an operating wavelength range of the range finding system.
Example 36. The method of any of Examples 28-35, wherein the background signal is generated based at least in part on sensor signals different from the sensor signal.
Example 37. The method of any of Examples 28-36, wherein the pixel comprises a plurality of microcells.
Example 38. The method of Example 37, wherein the sensor signal is generated by a portion of the plurality of microcells.
Example 39. The method of any of Examples 28-38, wherein generating a plurality of background signals comprises generating, by the at least one processor, at least a portion of the plurality of background signals at least partially based on a portion of the light received from the optical system having wavelengths different from a wavelength of the optical probe signal.
Example 40. The method of any of Examples 28-39, wherein the second light source comprises another light emitting system different from the range finding system, or sun light.
Example 41. The method of any of Examples 28-40, wherein the at least one processor generates the background signal and the return signal using a portion of the sensor signal.
Example 42. The method of any of Examples 28-41, wherein the return signal is generated using a first portion of the sensor signal and the background signal is generated using a second portion of the sensor signal different than the first portion.
Example 43. The method of Example 42, wherein the first and second portions of the sensor signal are received at two different measurement time windows.
Example 44. The method of Example 43, wherein the two different measurement time windows are non-overlapping.
Example 45. The method of any of Examples 28-44, wherein the background signal is generated using sensor signals generated by the pixel during one or more measurement time windows.
Example 46. The method of any of Example 28-45, wherein the feedback signal indicates an amplitude distribution of background signals over a plurality of pixels of the sensor.
Example 47. The method of any of Examples 28-46, wherein dynamically adjusting the optical system, by the at least one processor, increases a signal-to-noise ratio of at least one of a subsequent return signal generated after the return signal or a subsequent sensor signal generated after the sensor signal.
Example 48. The method of any of Examples 28-47, wherein dynamically adjusting the optical system comprises, by the at least one processor:
identifying one or more noisy pixels of the sensor that are associated with background signals larger than a threshold value to identify a portion of a field of view from which light is directed to the one or more noisy pixels; and
changing the field of view based on the identified portion of the field of view to reduce a level of background light received by at least a portion of the one or more noisy pixels.
Example 49. The method of any of Examples 28-48, wherein the optical system comprises at least one reconfigurable spatial optical filter and wherein dynamically adjusting the optical system comprises:
identifying a noisy pixel of the sensor that is associated with a background signal having magnitudes larger than a threshold value;
identifying a direction along which at least a portion of light directed to the noisy pixel is received from the environment;
adjusting the reconfigurable spatial optical filter to reduce an amount of light received from the environment along the identified direction.
Example 50. The method of any of Examples 28-49, wherein dynamically adjusting the readout system comprises adjusting, by the at least one processor an event validation threshold level, by the at least one processor.
Example 51. The method of any of Examples 28-49, wherein dynamically adjusting readout system, comprises, by the at least one processor:
identifying pixels that generate background signals having magnitudes larger than a threshold level using the feedback signal; and
adjusting the readout system to reduce contribution of sensor signals generated by the identified pixels, in generation of the at least a portion of the plurality of sensor signals and/or the plurality of return signals.
Example 52. The method of Example 51, wherein dynamically adjusting the sensor comprises, by the at least one processor, turning off the identified pixels or changing a bias voltage of the identified pixels.
Example 53. The method of any of Examples 28-52, further comprising generating, by the at least one processor, at least a confidence signal that indicates a probability that the return signal corresponds to the reflection of the optical probe signal from an object in the environment.
Example 54. At least one non-transitory storage media storing machine-executable instructions that, when executed by the at least one processor, cause the at least one processor to:
obtain a plurality of sensor signals from a sensor, wherein the plurality of sensor signals are response to light received at an optical system of a rangefinding system from an environment, wherein the sensor comprises a plurality of pixels, and wherein a pixel of the plurality of pixels generates a sensor signal of the plurality of sensor signals;
generate a plurality of return signals based on the plurality of sensor signals using a readout system, wherein a return signal of the plurality of return signals is generated using the sensor signal, wherein the return signal is configured to indicate a reflection of an optical probe signal, wherein the optical probe signal is generated by a first light source of the rangefinding system,
generate a plurality of background signals based at least in part on the plurality of sensor signals using the readout system, wherein a background signal of the plurality of background signals is generated based at least in part on the sensor signal, and wherein the background signal is configured to indicate a magnitude of light generated by a second light source different from the first light source, and
generate a feedback signal based at least in part on the background signal using the readout system,
dynamically adjust at least one of the optical system, the sensor, or the readout system, based on the feedback signal.
Example 55. The at least one non-transitory storage media of Example 54, wherein by dynamically adjusting at least one of the optical system, the sensor, or the readout system, the at least one processor:
reduces a false alarm rate of the range finding system, wherein the false alarm rate indicates a rate of generation of return signals that are not associated with a reflection of an optical probe signal; or
improves a detection of probability of the range finding system.
Example 56. The at least one non-transitory storage media of any of Examples 54 and 55, wherein by dynamically adjusting at least one of the optical system, the sensor, or the readout system, the at least one processor increases a signal-to-noise ratio of at least one of a subsequent return signal generated after the return signal or a subsequent sensor signal generated after the sensor signal.
Example 57. The at least one non-transitory storage media of any of Examples 54-56, wherein the sensor comprises at least one reference pixel or reference subpixel and the background signal is generated at least partly by the at least one reference pixel or reference subpixel.
Example 58. The at least one non-transitory storage media of Example 57 wherein the at least one reference pixel or reference subpixel comprises an optical filter having a passband broader than an operating wavelength range of the range finding system.
Example 59. The at least one non-transitory storage media of any of Examples 57 and 58 wherein the background signal is generated based at least in part on a reference sensor signal.
Example 60. The at least one non-transitory storage media of Example 59, wherein the reference sensor signal is generated at least partly by a reference subpixel of the pixel, and wherein the reference sensor signal is at least partially associated with a portion of the light received from the optical system having wavelengths different from a wavelength of the optical probe signal.
Example 61. The at least one non-transitory storage media of Example 60, wherein the reference subpixel comprises an optical filter having a passband broader than an operating wavelength range of the range finding system.
Example 62. The at least one non-transitory storage media of any of Examples 54-60, wherein the background signal is generated based at least in part on sensor signals different from the sensor signal.
Example 63. The at least one non-transitory storage media of any of Examples 54-62, wherein the pixel comprises a plurality of microcells.
Example 64. The at least one non-transitory storage media of Example 63, wherein the sensor signal is generated by a portion of the plurality of microcells.
Example 65. The at least one non-transitory storage media of any of Examples 54-64, wherein the instructions cause the processor to generate the plurality of background signals by generating at least a portion of the background signals at least partially based on a portion of the light received from the optical system having wavelengths different from a wavelength of the optical probe signal
Example 66. The at least one non-transitory storage media of any of Examples 54-65, wherein the second light source comprises another light emitting system different from the range finding system, or sun light.
Example 67. The at least one non-transitory storage media of any of Examples 54-66, wherein the instructions cause the processor to generate the background signal and the return signal using a portion of the sensor signal.
Example 68. The at least one non-transitory storage media of any of Examples 54-67, wherein the return signal is generated using a first portion of the sensor signal and the background signal is generated using a second portion of the sensor signal different than the first portion.
Example 69. The at least one non-transitory storage media of Example 68, wherein the first and second portions of the sensor signal are received at two different measurement time windows.
Example 70. The at least one non-transitory storage media of Example 69, wherein the two different measurement time windows are non-overlapping.
Example 71. The at least one non-transitory storage media of any of Examples 54-70, wherein the instructions cause the processor to generate the background signal using sensor signals generated by the pixel during one or more measurement time windows.
Example 72. The at least one non-transitory storage media of any of Example 54-71, wherein the feedback signal indicates an amplitude distribution of background signals over a plurality of pixels of the sensor.
Example 73. The at least one non-transitory storage media of any of Examples 54-72, wherein by dynamically adjusting the optical system, the processor increases a signal-to-noise ratio of at least one of a subsequent return signal generated after the return signal or a subsequent sensor signal generated after the sensor signal.
Example 74. The at least one non-transitory storage media of any of Examples 54-73, wherein the instructions cause the processor to dynamically adjust the optical system by:
identifying one or more noisy pixels of the sensor that are associated with background signals larger than a threshold value to identify a portion of a field of view from which light is directed to the one or more noisy pixels; and
changing the field of view based on the identified portion of the field of view to reduce a level of background light received by at least a portion of the one or more noisy pixels.
Example 75. The at least one non-transitory storage media of any of Examples 54-74, wherein the optical system comprises at least one reconfigurable spatial optical filter and wherein the instructions cause the processor to dynamically adjust the optical system by:
identifying a noisy pixel of the sensor that is associated with a background signal having magnitudes larger than a threshold value;
identifying a direction along which at least a portion of light directed to the noisy pixel is received from the environment;
adjusting the reconfigurable spatial optical filter to reduce an amount of light received from the environment along the identified direction.
Example 76. The at least one non-transitory storage media of any of Examples 54-75, wherein the instructions cause the processor to dynamically adjust the readout system by adjusting an event validation threshold level.
Example 77. The at least one non-transitory storage media of any of Examples 54-76, wherein the instructions cause the processor to dynamically adjust at least one of the optical system, sensor, or readout system, to reduce a signal-to-noise ratio of at least a portion of the plurality of sensor signals and/or the plurality of return signals by:
identifying pixels that generate background signals having magnitudes larger than a threshold level using the feedback signal; and
adjusting the readout system to reduce contribution of sensor signals generated by the identified pixels, in generation of the at least a portion of the plurality of sensor signals and/or the plurality of return signals.
Example 78. The at least one non-transitory storage media of Example 77, wherein the instructions cause the processor to dynamically adjust the optical system by turning off the identified pixels or changing a bias voltage of the identified pixels.
Example 79. The at least one non-transitory storage media of any of Examples 54-78, wherein the instructions further cause the processor to generate at least a confidence signal that indicates a probability that the return signal corresponds to the reflection of the optical probe signal from an object in the environment.

### Group 2

Example 1. A system, comprising:
an optical system configured to receive light from an environment through a field of view of the system;
a sensor configured to receive the light from the optical system and generate a plurality of sensor signals in response to the light, the sensor comprising a plurality of pixels, wherein a pixel of the plurality of pixels generates a sensor signal of the plurality of sensor signals
a readout system configured to:
generate a plurality of return signals based on the plurality of sensor signals received from the sensor, wherein a return signal of the plurality of return signals is generated using the sensor signal, wherein the return signal is configured to indicate a reflection of an optical probe signal received from the environment, wherein the optical probe signal is generated by a first light source of the system,
generate a plurality of background signals based at least in part on the plurality of sensor signals received from the sensor, wherein a background signal of the plurality of background signals is generated based at least in part on the sensor signal, wherein the background signal is configured to indicate an amount of light generated by a second light source different from the first light source, and
generate a confidence signal based at least in part on the background signal, wherein the confidence signal indicates a probability that at least the return signal is associated with the reflection of the optical probe signal.
Example 2. The system of Example 1, wherein the readout system generates the confidence signal based at least in part on the return signal.
Example 3. The system of any of Examples 1-2, wherein the sensor comprises at least one reference pixel or reference subpixel and the background signal is generated at least partially by the at least one reference pixel or reference subpixel.
Example 4. The system of Example 3 wherein the at least one reference pixel or reference subpixel comprises an optical filter having a passband broader than an operating wavelength range of the system.
Example 5. The system of any of Examples 1-4 wherein the readout system generates the background signal based at least in part on a reference sensor signal.
Example 6. The system of Example 5, wherein the reference sensor signal is generated at least partially by a reference subpixel of the pixel, and wherein the reference sensor signal is at least partially associated with a portion of the light received from the optical system comprising wavelengths different from a wavelength of the optical probe signal.
Example 7. The system of Example 6, wherein the reference subpixel comprises an optical filter having a passband broader than an operating wavelength range of the system.
Example 8. The system of any of Examples 1-7, wherein the readout system generates the background signal based at least in part on another sensor signal of the plurality of sensor signals.
Example 9. The system of any of Examples 1-8, wherein the pixel comprises a plurality of microcells.
Example 10. The system of Example 9, wherein the sensor signal comprises is generated by at least a portion of the plurality of microcells.
Example 11. The system of any of Examples 1-10, wherein at least a portion of the plurality of background signals are generated at least partially based on a portion of the light received from the optical system having wavelengths different from a wavelength of the optical probe signal.
Example 12. The system of any of Examples 1-11, wherein the second light source comprises another light emitting system, or sun light.
Example 13. The system of any of Examples 1-12, wherein the readout system generates the background signal and the return signal using a portion of the sensor signal.
Example 14. The system of any of Examples 1-13, wherein the readout system generates the return signal using a first portion of the sensor signal and generates the background signal using a second portion of the sensor signal different than the first portion of the sensor signal.
Example 15. The system of Example 14, wherein the first and second portions of the sensor signal are received at two different measurement time windows.
Example 16. The system of Example 15, wherein the two different measurement time windows are non-overlapping.
Example 17. The system of any of Examples 1-16, wherein the readout system generates the background signal using sensor signals generated by the pixel during two or more measurement time windows.
Example 18. The system of any of Examples 1-17, wherein the confidence signal indicates a false alarm rate of the system.
Example 19. The system of Example 18, wherein the false alarm rate is associated with the pixel.
Example 20. The system of any of Examples 1-19, wherein the readout system generates the confidence signal for the return signal based at least in part on at least one of another background signal of the plurality of background signals or another return signal of the plurality of return signals.
Example 21. The system of Example 20, wherein the readout system further generates a confidence signal for each of other return signals of the plurality of return signals based on at least a portion of the plurality of background signals.
Example 22. The system of Examples 21, wherein the readout system generates the confidence signal for each of other return signals of the plurality of return signals based on at least a portion of the plurality of return signals.
Example 23. The system of an of Example 1-22, wherein the confidence signal comprises a single value or multiple values indicating a magnitude of a background signal, probability of detection, an interference condition, an internal noise level of the system, or a false alarm rate of the system.
Example 24. A method implemented by a readout system of a rangefinding system comprising at least one processor, the method comprising:
obtaining, by the at least one processor, a plurality of sensor signals from a sensor, wherein the plurality of sensor signals are response to light received at an optical system from an environment, wherein the sensor comprises a plurality of pixels, and wherein a pixel of the plurality of pixels generates a sensor signal of the plurality of sensor signals; generating, by the at least one processor, a plurality of return signals based on the plurality of sensor signals received by a readout system, wherein a return signal of the plurality of return signals is generated using the sensor signal, wherein the return signal is configured to indicate a reflection of an optical probe signal, wherein the optical probe signal is generated by a first light source of the rangefinding system,
generating, by the at least one processor, a plurality of background signals based at least in part on the plurality of sensor signals received by the readout system, wherein a background signal of the plurality of background signals is generated based at least in part on the sensor signal, and wherein the background signal is configured to indicate a magnitude of light generated by a second light source different from the first light source, and
generating, by the at least one processor, a confidence signal based at least in part on the background signal generated by the readout system, wherein the confidence signal indicates a probability that at least the return signal is associated with the reflection of the optical probe signal.
Example 25. The method of Example 24, wherein the confidence signal is further generated based at least in part on the return signal.
Example 26. The method of any of Examples 24-25, wherein the sensor comprises at least one reference pixel or reference subpixel and the background signal is generated at least partially by the at least one reference pixel or reference subpixel.
Example 27. The method of Example 26 wherein the at least one reference pixel or reference subpixel comprises an optical filter having a pas sband broader than an operating wavelength range of the range finding system.
Example 28. The method of any of Examples 24-27 wherein the background signal is generated based at least in part on a reference sensor signal.
Example 29. The method of Example 28, wherein the reference sensor signal is generated at least partially by a reference subpixel of the pixel, and wherein the reference sensor signal is at least partially associated with a portion of the light received from the optical system comprising wavelengths different from a wavelength of the optical probe signal.
Example 30. The method of Example 29, wherein the reference subpixel comprises an optical filter having a passband broader than an operating wavelength range of the rangefinding system.
Example 31. The method of any of Examples 24-30, wherein the background signal is further generated based at least in part on another sensor signal of the plurality of sensor signals.
Example 32. The method of any of Examples 24-31, wherein the pixel comprises a plurality of microcells.
Example 33. The method of Example 9, wherein the sensor signal comprises is generated by at least a portion of the plurality of microcells.
Example 34. The method of any of Examples 24-33, wherein the at least one processor generates at least a portion of the plurality of background signals at least partially based on a portion of the light received from the optical system having wavelengths different from a wavelength of the optical probe signal.
Example 35. The method of any of Examples 24-34, wherein the second light source comprises another light emitting system, or sun light.
Example 36. The method of any of Examples 24-35, wherein the background signal and the return signal are generated using a portion of the sensor signal.
Example 37. The method of any of Examples 24-36, wherein the return signal is generated using a first portion of the sensor signal and the background signal is generated using a second portion of the sensor signal different than the first portion of the sensor signal.
Example 38. The method of Example 37, wherein the first and second portions of the sensor signal are received at two different measurement time windows.
Example 39. The method of Example 38, wherein the two different measurement time windows are non-overlapping.
Example 40. The method of any of Examples 24-39, wherein the background signal is generated using sensor signals generated by the pixel during two or more measurement time windows.
Example 41. The method of any of Examples 24-40, wherein the confidence signal indicates a false alarm rate of the range finding system.
Example 42. The method of Example 18, wherein the false alarm rate is associated with the pixel.
Example 43. The method of any of Examples 24-42, wherein generating the confidence signal comprises generating the confidence signal for the return signal based at least in part on at least one of another background signal of the plurality of background signals or another return signal of the plurality of return signals.
Example 44. The method of Example 43, wherein generating the confidence signal further comprises generating a confidence signal for each of other return signals of the plurality of return signals based on at least a portion of the plurality of background signals.
Example 45. The method of Example 44, wherein generating the confidence for each of other return signals of the plurality of return signals comprises generating the confidence signal based on at least a portion of the plurality of return signals.
Example 46. The method of any of Examples 24-45, wherein the confidence signal comprises a single value or multiple values indicating a magnitude of a background signal of the plurality of background signals, a probability of detection, an interference condition, an internal noise level of the rangefinding system, or a false alarm rate of the range finding system.
Example 47. At least one non-transitory storage media storing machine-executable instructions that, when executed by at least one processor of a rangefinding system, cause the at least one processor to:
obtain a plurality of sensor signals from a sensor, wherein the plurality of sensor signals are response to light received at an optical system from an environment, wherein the sensor comprises a plurality of pixels, and wherein a pixel of the plurality of pixels generates a sensor signal of the plurality of sensor signals;
generate a plurality of return signals based on the plurality of sensor signals using a readout system, wherein a return signal of the plurality of return signals is generated using the sensor signal, wherein the return signal is configured to indicate a reflection of an optical probe signal, wherein the optical probe signal is generated by a first light source of the rangefinding system,
generate a plurality of background signals based at least in part on the plurality of sensor signals using the readout system, wherein a background signal of the plurality of background signals is generated based at least in part on the sensor signal, and wherein the background signal is configured to indicate a magnitude of light generated by a second light source different from the first light source, and
generate a confidence signal based at least in part on the background signal, wherein the confidence signal indicates a probability that at least the return signal is associated with the reflection of the optical probe signal.
Example 48. The at least one non-transitory storage media of Example 47, wherein the instructions further cause the processor to generate the confidence signal based at least in part on the return signal.
Example 49. The at least one non-transitory storage media of any of Examples 47-48, wherein the sensor comprises at least one reference pixel or reference subpixel and the background signal is generated at least partially by the at least one reference pixel or reference subpixel.
Example 50. The at least one non-transitory storage media of Example 49, wherein the at least one reference pixel or reference subpixel comprises an optical filter having a passband broader than an operating wavelength range of the range finding system.
Example 51. The at least one non-transitory storage media of any of Examples 47-50 wherein the processor generates the background signal based at least in part on a reference sensor signal.
Example 52. The at least one non-transitory storage media of Example 51, wherein the instructions cause processor to generate the reference sensor signal at least partially using a reference subpixel of the pixel, and wherein the reference sensor signal is at least partially associated with a portion of the light received from the optical system comprising wavelengths different from a wavelength of the optical probe signal.
Example 53. The at least one non-transitory storage media of Example 52, wherein the reference subpixel comprises an optical filter having a passband broader than an operating wavelength range of the range finding system.
Example 54. The at least one non-transitory storage media of any of Examples 47-53, wherein the instructions further cause the processor to generate the background signal based at least in part on another sensor signal of the plurality of sensor signals.
Example 55. The at least one non-transitory storage media of any of Examples 47-54, wherein the pixel comprises a plurality of microcells.
Example 56. The at least one non-transitory storage media of Example 55, wherein the instructions cause processor to generate the sensor signal is using at least a portion of the plurality of microcells.
Example 57. The at least one non-transitory storage media of any of Examples 47-56, wherein the instructions cause processor to generate at least a portion of the plurality of background signals at least partially based on a portion of the light received from the optical system having wavelengths different from a wavelength of the optical probe signal.
Example 58. The at least one non-transitory storage media of any of Examples 47-57, wherein the second light source comprises another light emitting system, or sun light.
Example 59. The at least one non-transitory storage media of any of Examples 47-58, wherein the instructions cause processor to generate the background signal and the return signal using a portion of the sensor signal.
Example 60. The at least one non-transitory storage media of any of Examples 47-59, wherein the instructions cause processor to generate the return signal using a first portion of the sensor signal and generates the background signal using a second portion of the sensor signal different than the first portion of the sensor signal.
Example 61. The at least one non-transitory storage media of Example 60, wherein the first and second portions of the sensor signal are received at two different measurement time windows.
Example 62. The at least one non-transitory storage media of Example 61, wherein the two different measurement time windows are non-overlapping.
Example 63. The at least one non-transitory storage media of any of Examples 47-62, wherein the processor generates the background signal using sensor signals generated by the pixel during two or more measurement time windows.
Example 64. The at least one non-transitory storage media of any of Examples 47-63, wherein the confidence signal indicates a false alarm rate of the range finding system.
Example 65. The at least one non-transitory storage media of Example 64, wherein the false alarm rate is associated with the pixel.
Example 66. The at least one non-transitory storage media of any of Examples 47-65, wherein the instructions cause processor to generate the confidence signal for the return signal, based at least in part on at least one of another background signal of the plurality of background signals or another return signal of the plurality of return signals.
Example 67. The at least one non-transitory storage media of Example 66, wherein the instructions further cause the processor generate a confidence signal for each of other return signals of the plurality of return signals based on at least a portion of the plurality of background signals.
Example 68. The at least one non-transitory storage media of any of Examples 67, wherein the instructions cause the processor to generate the confidence signal for each of other return signals of the plurality of return signals based on at least a portion of the plurality of return signals.
Example 69. The at least one non-transitory storage media of Example 47-68, wherein the confidence signal comprises a single value or multiple values indicating a magnitude of a background signal, probability of detection, an interference condition, an internal noise level of the range finding system, or a false alarm rate of the range finding system.

### Group 3

Example 1. A time-of-flight (TOF) LiDAR system, comprising:
an optical emission system configured to emit light to an environment;
an optical system configured to receive light from an environment;
a sensor configured to receive the light from the optical system and generate a plurality of signals in response to the light, the sensor comprising a plurality of pixels;
a readout system configured to:
   generate a plurality of return signals based on the plurality of sensor signals received from the sensor, wherein the plurality of return signals are configured to indicate reflection of optical probe signals generated by a light emitting source,
   generate a plurality of real-time background signals based at least in part on the plurality of sensor signals received from the sensor,
   generate a feedback signal based at least in part on at least a portion of the plurality of real-time background signals,
   a detection control system configured to use the feedback signal to dynamically adjust the optical system, the sensor, and or the readout system, to increase the detection of probability of the TOF lidar system and optimize a false alarm rate of the system, wherein the false alarm rate indicates a rate of generation of return signals that are not associated with a reflection of an optical probe signal.
Example 2. The system of Example 1, wherein the system is configured to increase the detection of probability of TOF lidar system, by increasing a Signal-to-noise ratio of at least a portion of the return signals using the plurality of real-time background signals.
Example 3. The system of any of Examples 1-3, wherein the sensor comprises at least one reference pixel configured to generate a reference sensor signal associated with a portion of the light received from the optical system having wavelengths different from a wavelength of the optical probe signals.
Example 4. The system of Example 3 wherein the reference pixel comprises an optical filter different from the optical filters included in other pixels of the sensor.
Example 5. The system of any of Examples 3-4 wherein the readout system generates the real-time background signals based at least in part on the reference pixel signal.
Example 6. The system of any of Examples 3-5, wherein the reference pixel is operated in a same or different operational mode or bias voltages.
Example 7. The system of any of Examples 3-6, wherein the reference pixel comprises a reference sup-pixel, wherein the sub-pixel has a second output separate from a first output associated with other sub-pixels or microcells of the pixel.
Example 8. The system of any of Examples 3-7, wherein the plurality of real-time background signals are generated using sensor signals generated by the reference pixel and other pixels.
Example 9. The system of Example 7, wherein the reference sub-pixel comprises a broadband optical filter and is operated in different operation mode or bias voltage compared to the other sub-pixels or microcells of the pixel.
Example 10. The system of any of Examples 3-9, wherein the readout system further generates the plurality of real-time background signals using the reference sensor signal.
Example 11. The system of any of any of Examples 3-10, wherein the readout system generates the plurality of real-time background signals based at least in part on sensor signals generated by the reference pixel.
Example 12. The system of any of Examples 1-11, wherein the readout system generates the plurality return signals using sensor signals generated during a first measurement time window and the plurality of real-time background signals using senor signals generated during the same measurement timing window, or a second measurement time window different from the first measurement time window.
Example 13. The system of Example 12, wherein the first and the second measurement time windows are non-overlapping.
Example 14. The system of any of Examples 1-13, wherein the feedback signal is indicative of the plurality of background signals.
Example 15. The system of any of Examples 1-14, wherein the detection control system is configured to control the optical system to change an optical path of the received light to the sensor.
Example 16. The system of Example 15, wherein the detection control system is configured to:
identify a portion of a field of view from which light is directed to a pixel that generates a sensor signal used for generating the plurality of real-time background signals; and
change the field of view to improve a signal-to-noise ratio of sensor signals.
Example 17. The system of any of Examples 1-16, wherein the optical system comprises at least one reconfigurable spatial optical filter and wherein the detection control system is configured to:
identify one or more pixels of the sensor that are associated with the plurality of real-time background signals to identify a direction along which a portion of light directed to these pixel is received from the environment;
adjust the reconfigurable spatial optical filter to reduce an amount of light received from the environment along part of identified direction.
Example 18. The system of any of Examples 1-18, wherein the detection control system is configured to control the readout system by adjusting an event validation threshold.
Example 19. The system of any of Examples 1-18, wherein the detection control system adjusts the sensor by turning at least one pixel off and/or changing a bias voltage of at least one pixel.
Example 20. The system of any of Examples 1-20, wherein the plurality of real-time feedback signals comprise at least a confidence signal that indicates a probability that one or more return signals are associated with the reflection of the optical probe signal from an object in the environment.

### Group 4

Example 1. A time-of-flight (TOF) LiDAR system, comprising:
an optical emission system configured to emit light to an environment;
an optical system configured to receive light from an environment;
a sensor configured to receive the light from the optical system and generate a plurality of signals in response to the light, the sensor comprising a plurality of pixels;
a readout system configured to:
   generate a plurality of return signals based on the plurality of sensor signals received from the sensor, wherein the plurality of return signals are configured to indicate reflection of optical probe signals generated by a light emitting source,
   generate a plurality of real-time background signals based at least in part on the plurality of sensor signals received from the sensor,
   generate a confidence signal based at least in part on the plurality of real-time background signals, wherein the confidence signal indicates a probability that one or more return signals are associated to the reflections of a plurality of optical probe signals received from the environment.
Example 2. The system of Example 1, wherein the sensor comprises at least one reference pixel configured to generate a reference sensor signal associated with a portion of the light received from the optical system having wavelengths different from a wavelength of the optical probe signal.
Example 3. The system of Example 2 wherein the reference pixel comprises an optical filter different having spectral response different from that of optical filters included in other pixels of the sensor.
Example 4. The system of any of Examples 2 and 3, wherein the reference pixel is operated in a same or different operational mode or bias voltages.
Example 5. The system of any of Examples 2-4, wherein the reference pixel comprises a reference sup-pixel, wherein the reference sub-pixel has a second output separate from a first output associated with other sub-pixels or microcells of the pixel.
Example 6. The system of any of Examples 2-5, wherein read-out system further generates the plurality of the real-time background signals using sensor signals generated by the reference pixel and other pixels.
Example 7. The system of Example 5, wherein the reference sub-pixel comprises a broadband optical filter and is operated in different operation mode or bias voltage compared to the other sub-pixels or microcells of the pixel.
Example 8. The system of any of Examples 2-7, wherein the readout system further generates the plurality of real-time background signals using the reference sensor signal.
Example 9. The system of any of Examples 1-8, wherein the readout system generates a return signal using a sensor signal generated during a first measurement time window and a real-time background signal using the same senor signal or a second measurement time window different from the first measurement time window.
Example 10. The system of example 9, wherein the first and the second measurement time windows are non-overlapping.
Example 11. The system of any of Examples 1-10, wherein the readout system generates a confidence signal for a return signal based on a real-time background signal generated using at least a sensor signal generated from which the return signal is generated.
Example 12. The system of any of Examples 1-11, wherein the readout system generates two different confidence signals for two different return signals based on the plurality real-time background signals generated using at least sensor signals from which the two different return signals are generated.
Example 13. The system of any of Examples 1-12, wherein the readout system generates a confidence signal for each of the plurality of return signals based on sensor signals generated during one or more measurement time windows.
Example 14. The system of example 13, wherein the confidence signal for a return signal indicates a false alarm rate for a pixel that generates the sensor signal from which the corresponding return signal is generated.
Example 15. The system of any of Examples 1-14, wherein the readout system further generates an overall confidence signal for a pixel, wherein the overall confidence signal is determined based on the confidence signals generated for return signals other than the return signal generated by the pixel.
Example 16. The system of any of Examples 1-15, wherein the confidence signal comprises a single value or multiple values indicating a background light level, a probability of signal detection, and interference condition, an internal noise level, and or a false alarm rate.

### Terminology

In this description numerous specific details are set forth in order to provide a thorough understanding of the present disclosure for the purposes of explanation. It will be apparent, however, that the embodiments described by the present disclosure can be practiced without these specific details. In some instances, well-known structures and devices are illustrated in block diagram form in order to avoid unnecessarily obscuring aspects of the present disclosure.

Specific arrangements or orderings of schematic elements, such as those representing systems, devices, modules, instruction blocks, data elements, and/or the like are illustrated in the drawings for ease of description. However, it will be understood by those skilled in the art that the specific ordering or arrangement of the schematic elements in the drawings is not meant to imply that a particular order or sequence of processing, or separation of processes, is required unless explicitly described as such. Further, the inclusion of a schematic element in a drawing is not meant to imply that such element is required in all embodiments or that the features represented by such element may not be included in or combined with other elements in some embodiments unless explicitly described as such.

Although the terms first, second, third, and/or the like are used to describe various elements, these elements should not be limited by these terms. The terms first, second, third, and/or the like are used only to distinguish one element from another. For example, a first contact could be termed a second contact and, similarly, a second contact could be termed a first contact without departing from the scope of the described embodiments. The first contact and the second contact are both contacts, but they are not the same contact.

The terminology used in the description of the various described embodiments herein is included for the purpose of describing particular embodiments only and is not intended to be limiting. As used in the description of the various described embodiments and the appended claims, the singular forms “a,” “an” and “the” are intended to include the plural forms as well and can be used interchangeably with “one or more” or “at least one,” unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this description specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when”, “upon”, “in response to determining,” “in response to detecting,” and/or the like, depending on the context. Similarly, the phrase “if it is determined” or “if [a stated condition or event] is detected” is, optionally, construed to mean “upon determining,” “in response to determining,” “upon detecting [the stated condition or event],” “in response to detecting [the stated condition or event],” and/or the like, depending on the context. Also, as used herein, the terms “has”, “have”, “having”, or the like are intended to be open-ended terms. Further, the phrase “based on” is intended to mean “based at least partially on” unless explicitly stated otherwise.

1. A system, comprising:
an optical system configured to receive light from an environment through a field of view of the system;
a sensor configured to receive the light from the optical system and generate a plurality of sensor signals in response to the light, the sensor comprising a plurality of pixels, wherein a pixel of the plurality of pixels generates a sensor signal of the plurality of sensor signals
a readout system configured to:
generate a plurality of return signals based on the plurality of sensor signals received from the sensor, wherein a return signal of the plurality of return signals is generated using the sensor signal, wherein the return signal is configured to indicate a reflection of an optical probe signal received from the environment, wherein the optical probe signal is generated by a first light source,
generate a plurality of background signals based at least in part on the plurality of sensor signals received from the sensor, wherein a background signal of the plurality of background signals is generated based at least in part on the sensor signal, wherein the background signal is configured to indicate an amount of light generated by a second light source different from the first light source, and
generate a confidence signal based at least in part on the background signal, wherein the confidence signal indicates a probability that at least the return signal is associated with the reflection of the optical probe signal.

2. The system of claim 1, wherein the readout system generates the background signal based at least in part on a reference sensor signal.

3. The system of claim 2, wherein the reference sensor signal is generated at least partially by a reference subpixel of the pixel, and wherein the reference sensor signal is at least partially associated with a portion of the light received from the optical system comprising wavelengths different from a wavelength of the optical probe signal.

4. The system of claim 1, wherein the readout system generates the background signal based at least in part on another sensor signal of the plurality of sensor signals.

5. The system of claim 1, wherein the second light source comprises another light emitting system, or sun light.

6. The system of claim 1, wherein the readout system generates the confidence signal for the return signal based at least in part on at least one of another background signal of the plurality of background signals or another return signal of the plurality of return signals.

7. The system of claim 6, wherein the readout system further generates a confidence signal for each of other return signals of the plurality of return signals based on at least a portion of the plurality of background signals.

8. The system of claim 7, wherein the readout system further generates the confidence signal for each of other return signals of the plurality of return signals based on at least a portion of the plurality of return signals.

9. A method implemented by a readout system comprising at least one processor of a range finding system, the method comprising:
obtaining, by the at least one processor, a plurality of sensor signals from a sensor, wherein the plurality of sensor signals are response to light received at an optical system from an environment, wherein the sensor comprises a plurality of pixels, and wherein a pixel of the plurality of pixels generates a sensor signal of the plurality of sensor signals; generating, by the at least one processor, a plurality of return signals based on the plurality of sensor signals received by a readout system, wherein a return signal of the plurality of return signals is generated using the sensor signal, wherein the return signal is configured to indicate a reflection of an optical probe signal, wherein the optical probe signal is generated by a first light source of the range finding system,
generating, by the at least one processor, a plurality of background signals based at least in part on the plurality of sensor signals received by the readout system, wherein a background signal of the plurality of background signals is generated based at least in part on the sensor signal, and wherein the background signal is configured to indicate a magnitude of light generated by a second light source different from the first light source, and
generating, by the at least one processor, a confidence signal based at least in part on the background signal generated by the readout system, wherein the confidence signal indicates a probability that at least the return signal is associated with the reflection of the optical probe signal.

10. The method of claim 9, wherein the background signal is generated based at least in part on a reference sensor signal.

11. The method of claim 10, wherein the reference sensor signal is generated at least partially by a reference subpixel of the pixel, and wherein the reference sensor signal is at least partially associated with a portion of the light received from the optical system comprising wavelengths different from a wavelength of the optical probe signal.

12. The method of claim 9, wherein the second light source comprises a light source of another light emitting system different from the range finding system, or sun light.

13. The method of claim 9, wherein generating the confidence signal comprises generating the confidence signal for the return signal based at least in part on at least one of another background signal of the plurality of background signals or another return signal of the plurality of return signals.

14. The method of claim 13, wherein generating the confidence signal further comprises generating a confidence signal for each of other return signals of the plurality of return signals based on at least a portion of the plurality of background signals.

15. The method of claim 14, wherein generating the confidence signal for each of other return signals of the plurality of return signals comprises generating the confidence signal based on at least a portion of the plurality of return signals.

16. At least one non-transitory storage media storing machine-executable instructions that, when executed by a readout system comprising at least one processor, cause the readout system to:
obtain a plurality of sensor signals from a sensor, wherein the plurality of sensor signals are response to light received at an optical system from an environment, wherein the sensor comprises a plurality of pixels, and wherein a pixel of the plurality of pixels generates a sensor signal of the plurality of sensor signals;
generate a plurality of return signals based on the plurality of sensor signals using a readout system, wherein a return signal of the plurality of return signals is generated using the sensor signal, wherein the return signal is configured to indicate a reflection of an optical probe signal, wherein the optical probe signal is generated by a first light source of a system,
generate a plurality of background signals based at least in part on the plurality of sensor signals using the readout system, wherein a background signal of the plurality of background signals is generated based at least in part on the sensor signal, and wherein the background signal is configured to indicate a magnitude of light generated by a second light source different from the first light source, and
generate a confidence signal based at least in part on the background signal, wherein the confidence signal indicates a probability that at least the return signal is associated with the reflection of the optical probe signal.

17. The at least one non-transitory storage media of claim 16, wherein the machine-executable instructions cause processor to generate at least a portion of the plurality of background signals at least partially based on a portion of the light received from the optical system having wavelengths different from a wavelength of the optical probe signal.

18. The at least one non-transitory storage media of claim 16, wherein the second light source comprises a light emitting system of another system, or sun light.

19. The at least one non-transitory storage media of claim 16, wherein the confidence signal indicates a false alarm rate of the system.

20. The at least one non-transitory storage media of claim 16, wherein the machine-executable instructions cause processor to generate the confidence signal for the return signal, based at least in part on at least one of another background signal of the plurality of background signals or another return signal of the plurality of return signals.
